(19) United States
(12) Patent Application Publication
(10) Pub. No.: US 2013/0176270 A1
(43) Pub. Date: Jul. 11, 2013

(54) OBJECT CLASSIFICATION FOR TOUCH PANELS

(71) Applicants: Federico S. Cattivelli, Newport Beach, CA (US); Bhupesh Kharwa, San Ramon, CA (US); Glen Weaver, San Jose, CA (US); Satish V. Joshi, Cupertino, CA (US); Kerrynn Jacques de Roche, San Jose, CA (US)

(72) Inventors: Federico S. Cattivelli, Newport Beach, CA (US); Bhupesh Kharwa, San Ramon, CA (US); Glen Weaver, San Jose, CA (US); Satish V. Joshi, Cupertino, CA (US); Kerrynn Jacques de Roche, San Jose, CA (US)

(73) Assignee: Broadcom Corporation, Irvine, CA (US)

(21) Appl. No.: 13/413,150

(22) Filed: Mar. 6, 2012

Related U.S. Application Data
(60) Provisional application No. 61/584,644, filed on Jan. 9, 2012.

(51) Int. Cl. G06F 3/045

(52) U.S. Cl. 345/174

(57) ABSTRACT

Control circuitry for a touch panel includes a touch panel interface, a memory including object classification logic, and a controller in communication with the memory and the touch panel interface. The controller is operable, when the object classification logic is executed, to perform selected processing of the touch panel heat map, including: classifying a touch as a hover touch, finger touch, or stylus touch; rejecting palm or other large object touches; rejecting knuckle touches; rejecting grip touches; and other processing.

### 1. CROSS REFERENCE TO RELATED APPLICATIONS

This application claims priority to, and incorporates by reference, U.S. Provisional Application Ser. No. 61/584,644, Titled Object Classification for Touch Panels, Filed 9 Jan. 2012.

### 2. TECHNICAL FIELD

This disclosure relates to methods and apparatus for capacitive touch screen devices.

### 3. BACKGROUND

Continual development and rapid improvement in portable devices has included the incorporation of touch screens in these devices. A touch screen device responds to a user's touch to convey information about that touch to a control circuit of the portable device. The touch screen is conventionally combined with a generally coextensive display device such as a liquid crystal display (LCD) to form a user interface for the portable device. The touch screen also operates with a touch controller circuit to form a touch screen device. In other applications using touch sensing, touch pads may also be part of the user interface for a device such as a personal computer, taking the place of a separate mouse for user interaction with the onscreen image. Relative to portable devices that include a keypad, rollerball, joystick or mouse, the touch screen device provides advantages of reduced moving parts, durability, resistance to contaminants, simplified user interaction and increased user interface flexibility.

Despite these advantages, conventional touch screen devices have been limited in their usage to date. For some devices, current drain has been too great. Current drain directly affects power dissipation which is a key operating parameter in a portable device. For other devices, performance such as response time has been poor, especially when subjected to fast motion at the surface of the touch screen. Some devices do not operate well in environments with extreme conditions for electromagnetic interference and contaminants that can affect performance.

Further limitations and disadvantages of conventional and traditional approaches will become apparent to one of ordinary skill in the art through comparison of such approaches with aspects of the present disclosure as set forth in the remainder of this application and with reference to the accompanying drawings.

### BRIEF DESCRIPTION OF THE DRAWINGS

The system may be better understood with reference to the following drawings and description. In the figures, like reference numerals designate corresponding parts throughout the different views.

FIG. 1 is an example block diagram of a portable device.

FIG. 2 is an example of a top view of a portable device.

FIG. 3 is a simplified diagram of an example mutual capacitance touch panel for use in the portable device of FIGS. 1 and 2.

FIG. 4 shows an example block diagram of the touch front end of the portable device of FIG. 1.

FIG. 5 shows an example first sample asymmetric scan map.

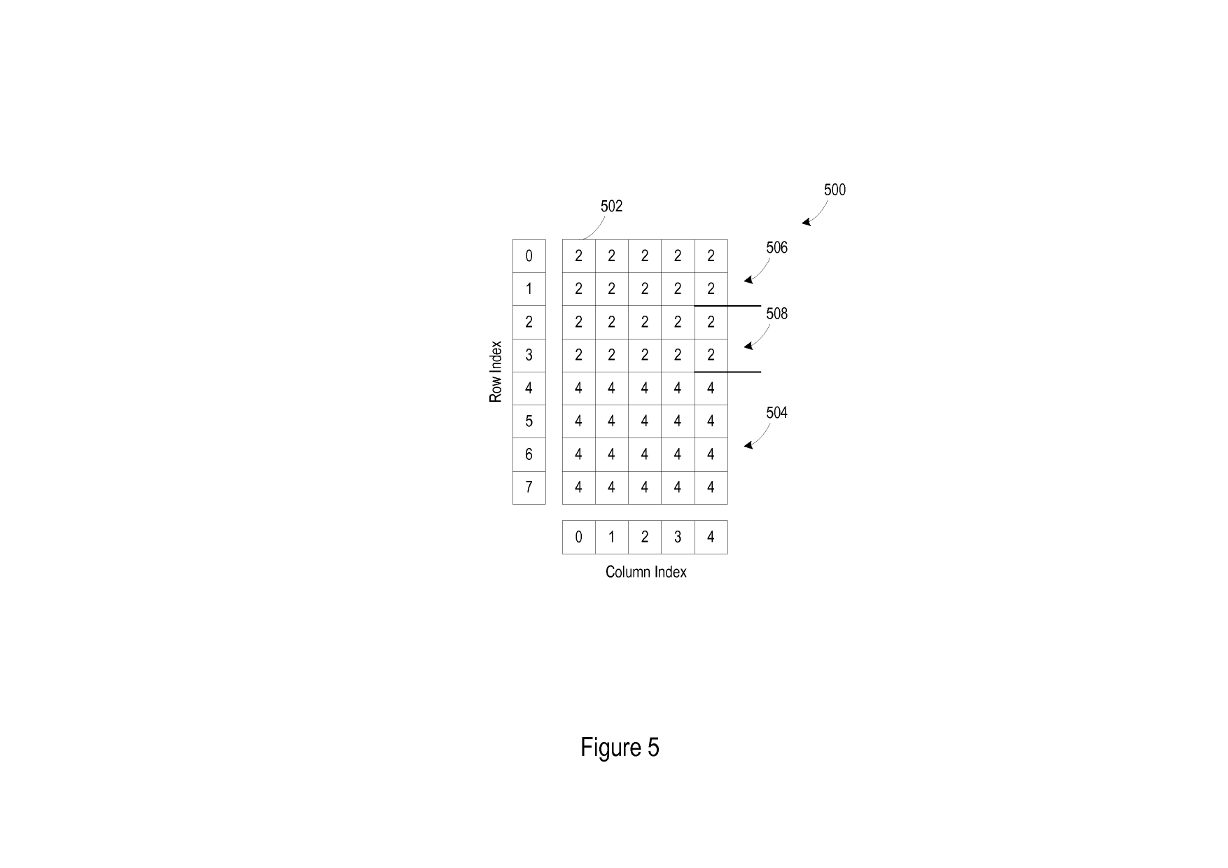

FIG. 6 shows an example second sample asymmetric scan map.

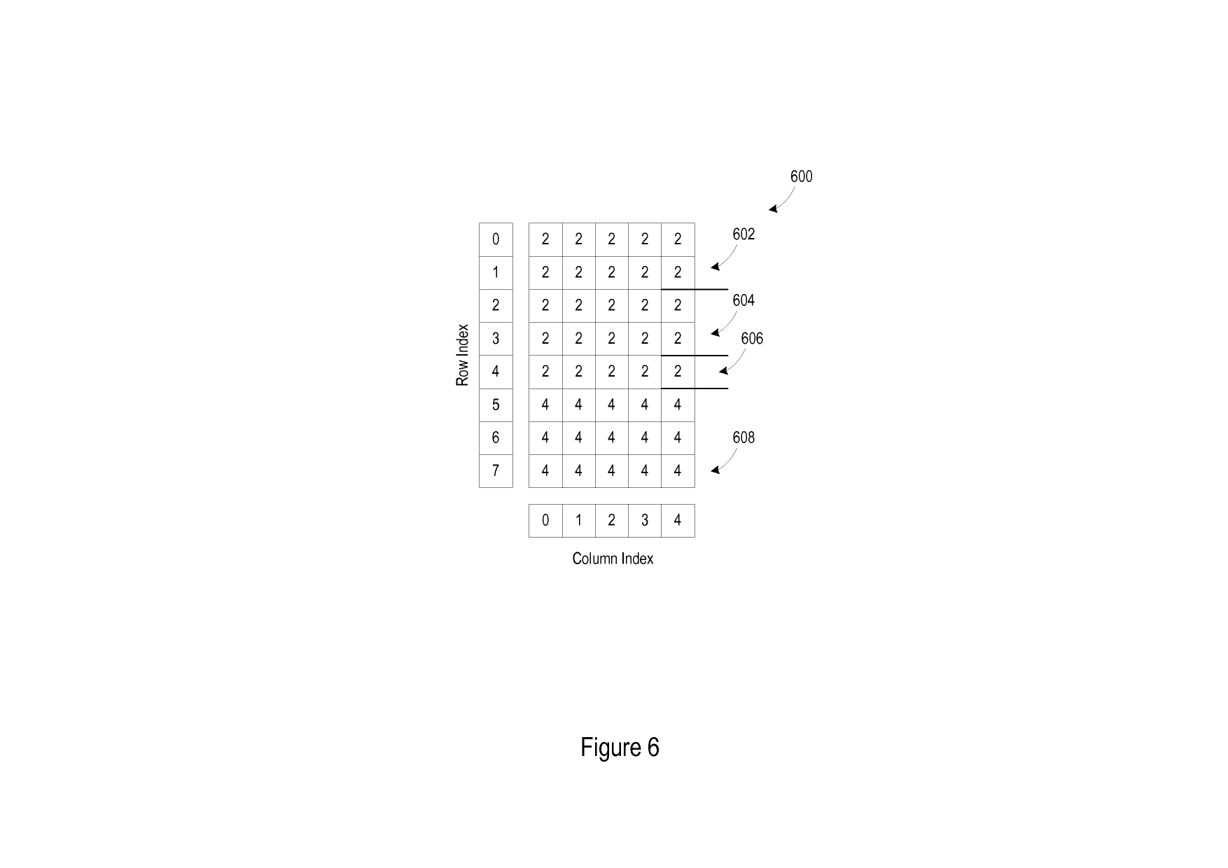

FIG. 7 shows an example high-level architecture of the touch front end of the portable device of FIG. 1.

FIG. 8 shows an example simplified capacitive touch panel and related circuitry.

FIG. 9 illustrates an example baseline tracking filter or use in a controller circuit for a portable device.

FIG. 10 shows an example first variance estimator in conjunction with the baseline tracking filter of FIG. 9.

FIG. 11 shows an example second variance estimator in conjunction with the baseline tracking filter of FIG. 9.

FIG. 12 shows an example smartphone that employs object classification logic.

FIG. 13 shows an example touch panel blob.

FIG. 14 shows exemplary touch classification regions.

FIG. 15 shows example blob shapes and classification into large object or multiple smaller objects

FIG. 16 shows example touch panel regions for grip suppression.

FIG. 17 shows example logic that that the object classification logic may implement.

### DETAILED DESCRIPTION

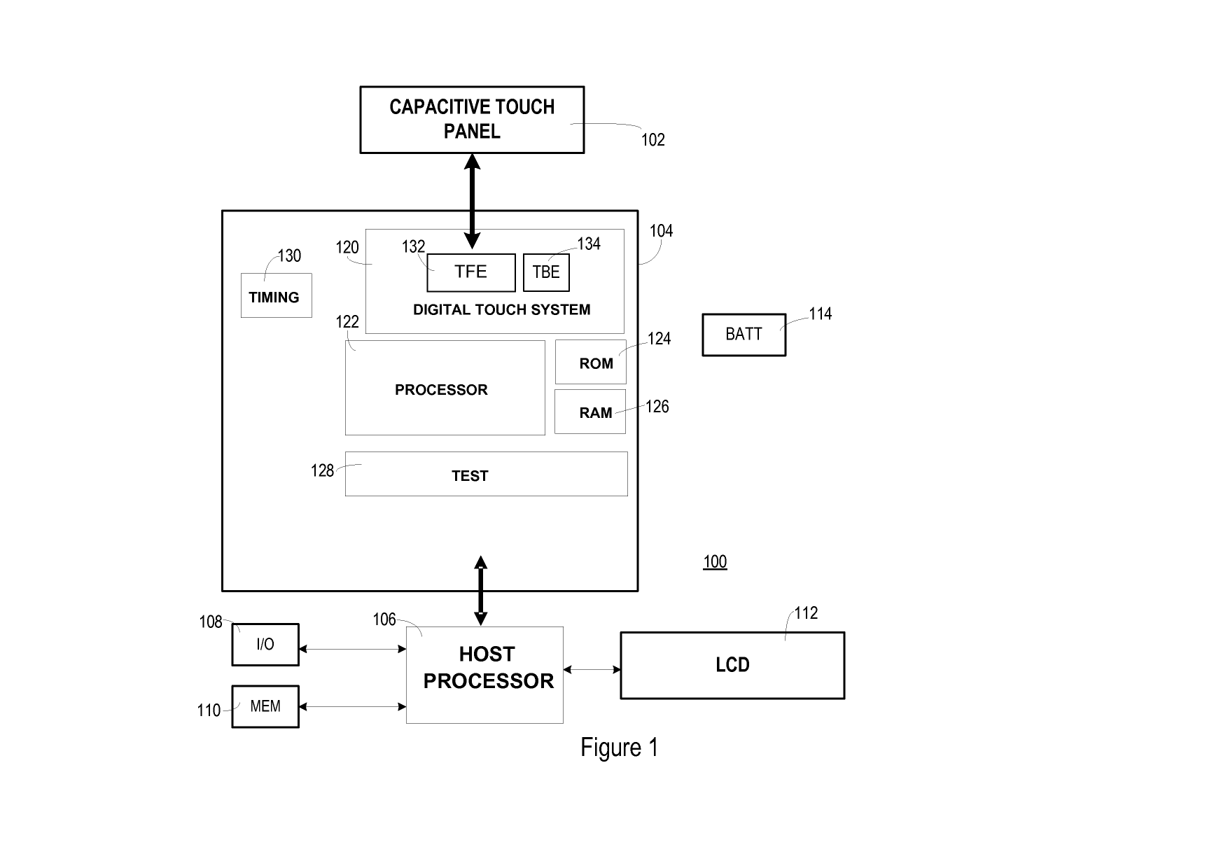

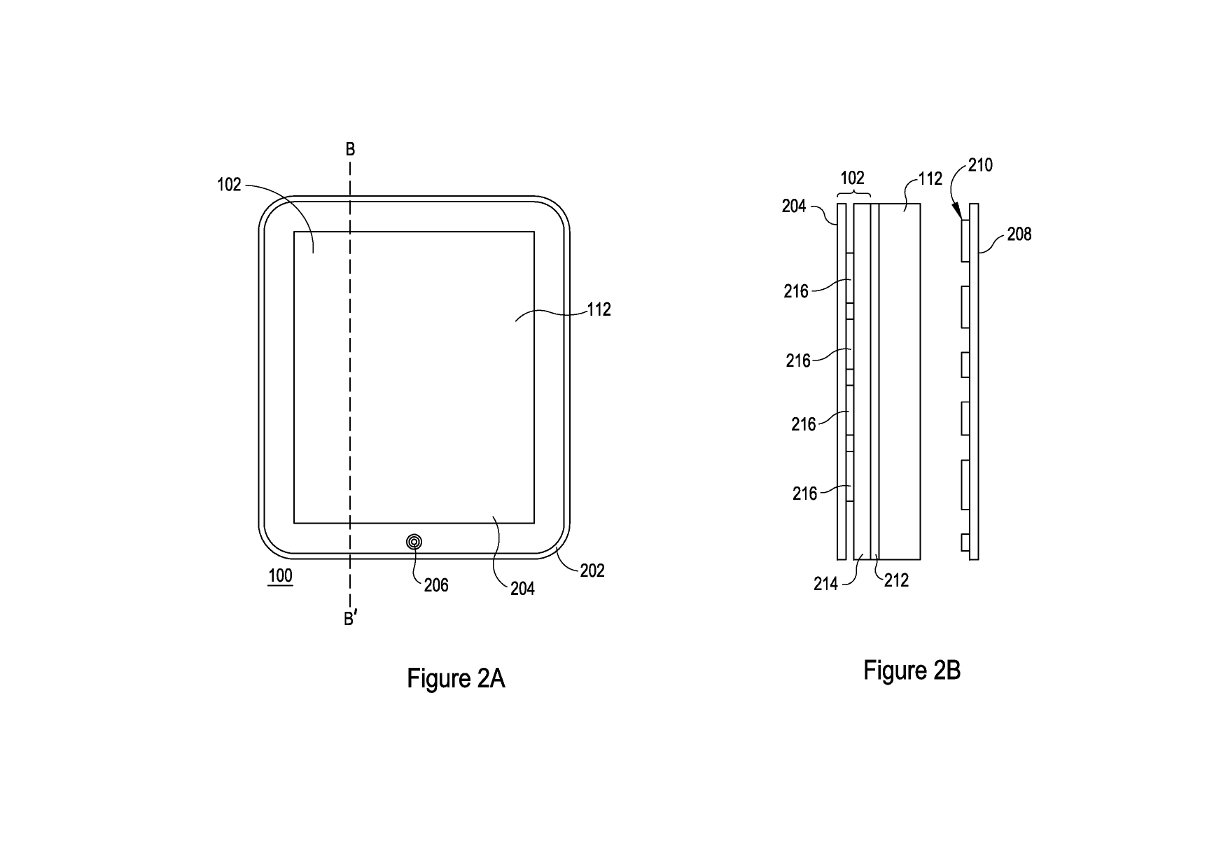

Referring now to FIGS. 1 and 2, FIG. 1 shows a block diagram of a portable device 100. FIG. 2 shows one embodiment of a portable device 100 according to the block diagram of FIG. 1. As shown in FIG. 1, the portable device 100 includes a capacitive touch panel 102, a controller circuit 104, a host processor 106, input-output circuit 108, memory 110, a liquid crystal display (LCD) 112 and a battery 114 to provide operating power.

FIG. 2 includes FIG. 2A which shows a top view of the portable device 100 and FIG. 2B which shows a cross-sectional view of the portable device 200 along the line B-B′ in FIG. 2A. The portable device may be embodied in a wide range of devices with a touch sensitive display, including, as examples, a tablet computer, a smart phone, music player, or a fixed device such as a kiosk.

The portable device 100 includes a housing 202, a lens or clear touch surface 204 and one or more actuatable user interface elements such as a control switch 206. Contained within the housing are a printed circuit board 208 circuit elements 210 arranged on the printed circuit board 208 and as are shown in block diagram form in FIG. 1. The capacitive touch panel 102 is arranged in a stack and includes a drive line 212, an insulator 214 and a sense line 216. The insulator electrically isolates the drive line 212 and other drive lines arranged parallel to the drive line from the sense lines 216. Signals are provided to one or more of the drive lines 212 and sensed by the sense lines 216 to locate a touch event on the clear touch surface 204. The LCD 112 is located between the printed circuit board 208 and the capacitive touch panel 102.

As is particularly shown in FIG. 2A, the capacitive touch panel 102 and the LCD 112 may be generally coextensive and form a user interface for the portable device. Text and images may be displayed on the LCD for viewing and interaction by a user. The user may touch the capacitive touch panel 102 to control operation of the portable device 100. The touch may be by a single finger of the user or by several fingers, or by other portions of the user's hand or other body parts. The touch may also be by a stylus gripped by the user or otherwise brought into contact with the capacitive touch panel. Touches may be intentional or inadvertent. In another application, the capacitive touch panel 102 may be embodied as a touch pad of a computing device. In such an application, the LCD 112 need not be coextensive (or co-located) with the capacitive touch panel 102 but may be located nearby for viewing by a user who touches the capacitive touch panel 102 to control the computing device.

Referring again to FIG. 1, the controller circuit 104 includes a digital touch system 120, a processor 122, memory including persistent memory 124 and read-write memory 126, a test circuit 128 and a timing circuit 130. In one embodiment, the controller circuit 104 is implemented as a single integrated circuit including digital logic and memory and analog functions.

The digital touch subsystem 120 includes a touch front end (TFE) 132 and a touch back end (TBE) 134. This partition is not fixed or rigid, but may vary according to the high-level function(s) that each block performs and that are assigned or considered front end or back end functions. The TFE 132 operates to detect the capacitance of the capacitive sensor that comprises the capacitive touch-panel 102 and to deliver a high signal to noise ratio (SNR) capacitive image (or heatmap) to the TBE 134. The TBE 134 takes this capacitive heatmap from the TFE 132 and discriminates, classifies, locates, and tracks the object(s) touching the capacitive touch panel 102 and reports this information back to the host processor 106. The TFE 132 and the TBE 134 may be partitioned among hardware and software or firmware components as desired, e.g., according to any particular design requirements. In one embodiment, the TFE 132 will be largely implemented in hardware components and some or all of the functionality of the TBE 134 may be implemented by the processor 122.

The processor 122 operates in response to data and instructions stored in memory to control the operation of the controller circuit 104. In one embodiment, the processor 122 is a reduced instruction set computer (RISC) architecture, for example as implemented in an ARM processor available from ARM Holdings. The processor 122 receives data from and provides data to other components of the controller circuit 104. The processor 122 operates in response to data and instructions stored in the persistent memory 124 and read-write memory 126 and in operation writes data to the memories 124, 126. In particular, the persistent memory 124 may store firmware data and instructions which are used by any of the functional blocks of the controller circuit 104. These data and instructions may be programmed at the time of manufacture of the controller 104 for subsequent use, or may be updated or programmed after manufacture.

The timing circuit 130 produces clock signals and analog, time-varying signals for use by other components of the controller circuit 104. The clock signals include digital clock signal for synchronizing digital components such as the processor 122. The time-varying signals include signals of predetermined frequency and amplitude for driving the capacitive touch panel 102. In this regard, the timing circuit 130 may operate under control or responsive to other functional blocks such as the processor 122 or the persistent memory 124.

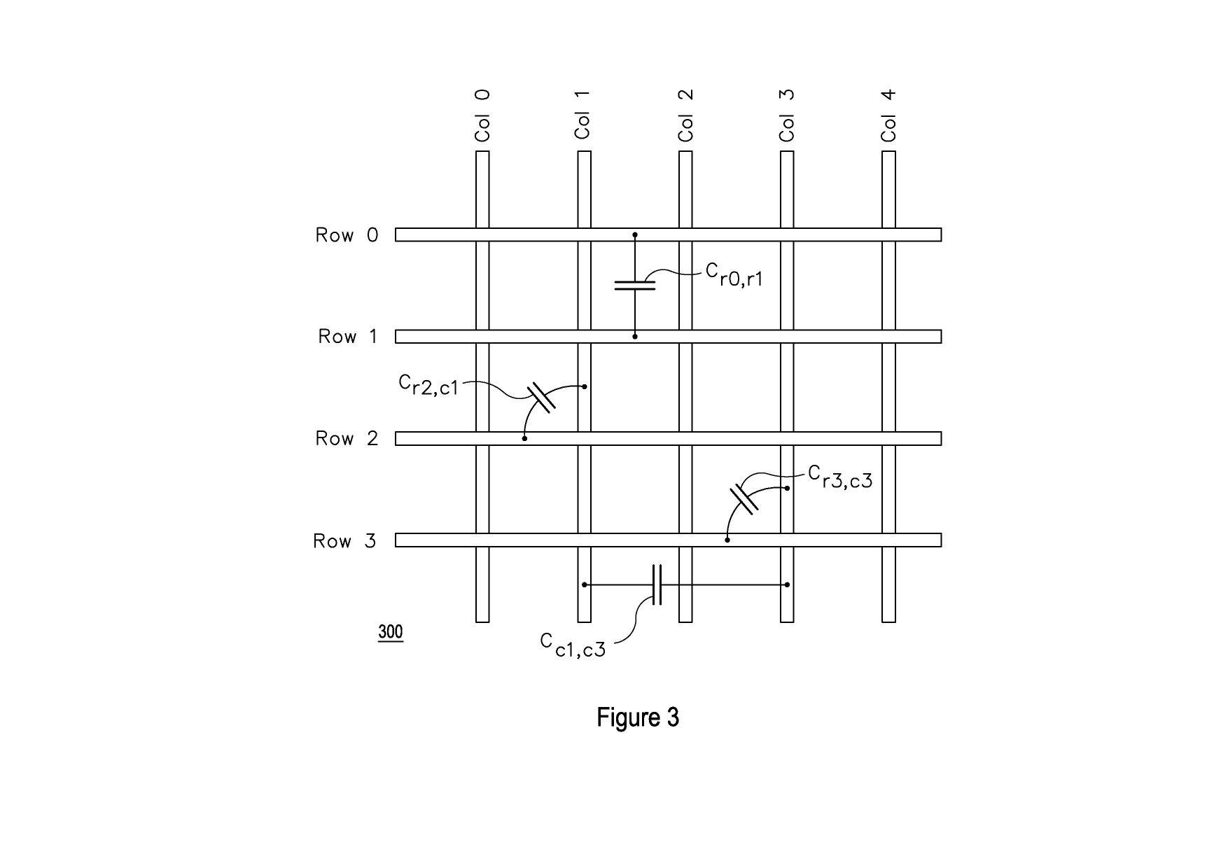

FIG. 3 shows a diagram of a typical mutual capacitance touch panel 300. The capacitive touch panel 300 models the capacitive touch panel 102 of the portable device of FIGS. 1 and 2. The capacitive touch panel 300 has N_{row} rows and N_{col} columns (N_{row}=4, N_{col}=5 in FIG. 3). In this manner, the capacitive touch panel 300 creates N_{row}-times-N_{col} mutual capacitors between the N_{row} rows and the N_{col} columns. These are the mutual capacitances that the controller circuit 104 commonly uses to sense touch, as they create a natural grid of capacitive nodes that the controller circuit 104 uses to create the typical capacitive heatmap. However, it is worth noting that there are a total of (N_{row}+N_{col})—or (N_{row}+N_{col}+2) nodes if a touching finger or stylus and ground node in the capacitive touch panel 300 are included. A capacitance exists between every pair of nodes in the capacitive touch panel 300.

Stimulus Modes

The capacitive touch panel 300 can be stimulated in several different manners. The way in which the capacitive touch panel 300 is stimulated impacts which of the mutual capacitances within the panel are measured. A list of the modes of operation is detailed below. Note that the modes defined below only describe the manner in which the TFE 132 stimulates the panel.

Row-column (RC) mode is a first operating mode of a mutual capacitive sensor. In RC mode, the rows are driven with transmit (TX) waveforms and the columns are connected to receive (RX) channels of the TFE 132. Therefore, the mutual capacitors between the rows and the columns are detected, yielding the standard N_{row}×N_{col} capacitive heatmap. In the example shown in FIG. 3, RC mode measures the capacitors label Cr_{<i>}, Cr_{<j>}, where <i> and <j> are integer indices of the row and column, respectively. Generally, there is no incremental value in supporting column-row (CR) mode, (e.g. driving the columns and sensing the rows), as it yields the same results as RC mode.

Self-capacitance column (SC) mode is a self-capacitance mode that may be supported by the controller 102. In SC mode, one or more columns are simultaneously driven and sensed. As a result, the total capacitance of all structures connected to the driven column can be detected.

In column-listening (CL) mode, the RX channels are connected to the columns of the capacitive touch panel 102 and the transmitter is turned off. The rows of the capacitive touch panel 102 will either be shorted to a low-impedance node (e.g. AC ground), or left floating (e.g. high-impedance). This mode is used to listen to the noise and interference present on the panel columns. The output of the RX channels will be fed to a spectrum estimation block (e.g. FFT block) in order to determine the appropriate signal frequencies to use and the optimal interference filter configuration, as will be described in further detail below.

Timing Terminology

Some terminology is introduced for understanding the various timescales by which results are produced within the TFE 132. The TFE 132 produces a capacitive heatmap by scanning all desired nodes of the capacitive touch panel 102 (e.g., all of the nodes, or some specified or relevant subset of all of the nodes). This process may be referred to as a frame scan; the frame scan may run at a rate referred to as the frame rate. The frame rate may be scalable. One exemplary frame rate include a frame rate of 250 Hz for single touch and a panel size less than or equal to 5.0 inches in size. A second exemplary frame rate is 200 Hz for single touch and a panel size greater than 5.0 inches. A third exemplary frame rate is 120 Hz minimum for 10 touches and a panel size of 10.1 inches. Preferably, the controller 104 can support all of these frame rates and the frame rate is configurable to optimize tradeoff of performance and power consumption for a given application. The term scan rate may be used interchangeably with the term frame rate.

The controller circuit 104 may assemble a complete frame scan by taking a number of step scans. Qualitatively, each step scan may result in a set of capacitive readings from the receivers, though this may not be strictly done in all instances. The controller circuit 104 may perform each step scan at the same or different step rate. For a row/column (RC) scan, where the transmitters are connected to the rows and the receivers are connected to the columns, it will take N_{row} step scans to create a full frame scan. Assuming a tablet-sized capacitive touch panel 102 with size 40 rows×30 columns, the step rate may be at least 8 kHz to achieve a 200 Hz frame rate.

For all mutual-capacitance scan modes a touch event causes a reduction in the mutual capacitance measured. The capacitive heatmap that is created by the TFE 132 will be directly proportional to the measured capacitance. Therefore, a touch event in these scan modes will cause a reduction in the capacitive heatmap. For all self-capacitance scan modes, a touch event causes an increase in the capacitance measured. The capacitive heatmap that is created by the TFE 132 will be directly proportional to the measured capacitance. Therefore, a touch event in these scan modes will cause a local increase in the capacitive heatmap.

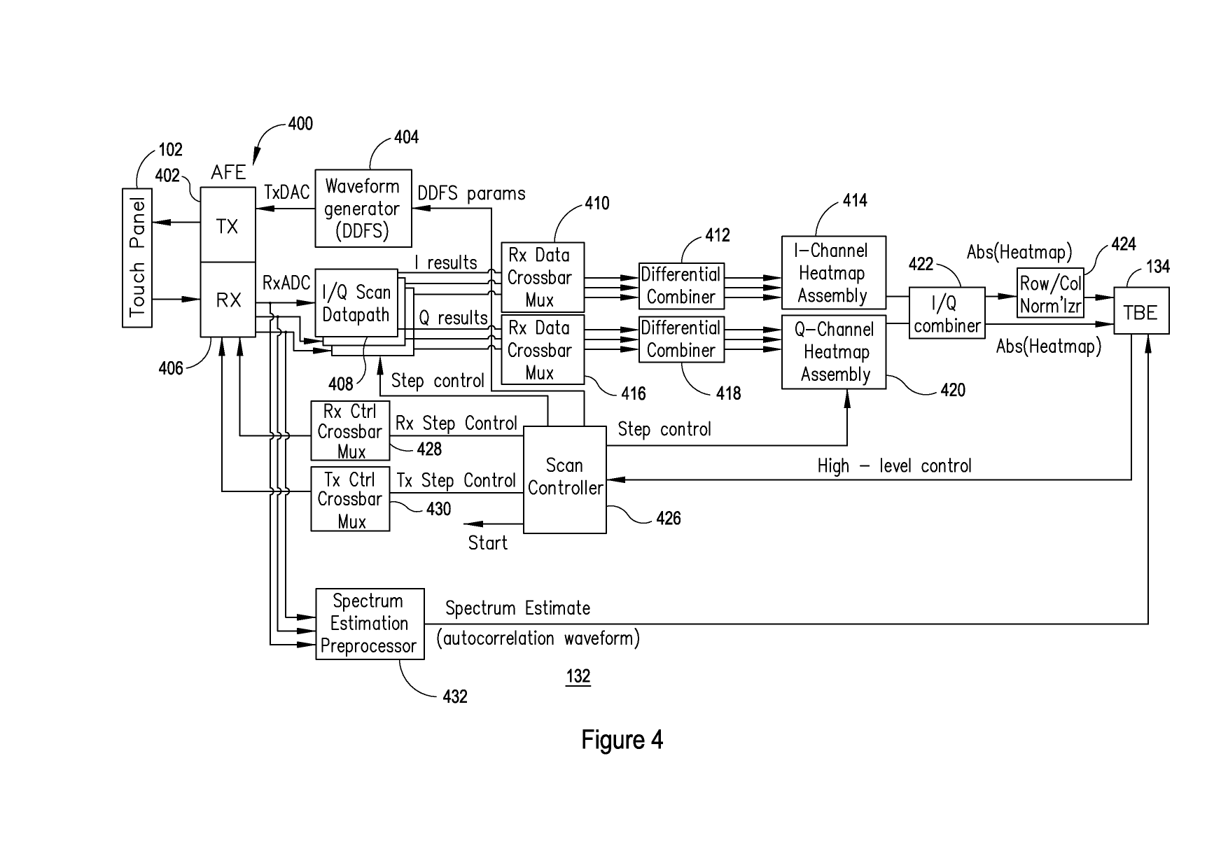

Referring now to FIG. 4, it shows a block diagram of the touch front end (TFE) 132 of FIG. 1. In the illustrated embodiment, the AFE 132 includes 48 physical transmit channels and 32 physical receive channels. Additionally, some embodiments of the AFE 132 may contain circuitry such as power regulation circuits, bias generation circuits, and clock generation circuitry. To avoid unduly crowding the drawing figure, such miscellaneous circuitry is not shown in FIG. 4.

The TFE 132 includes transmit channels 402, a waveform generation block 404, receive channels 406 and I/Q scan data paths 408. The transmit channels 402 and the receive channels 406 collectively may be referred to as the analog front end (AFE) 400. The TFE 132 further includes, for the in-phase results from the I/Q scan data path, a receive data crossbar multiplexer 410, a differential combiner 412 and an in-phase channel assembly block 414. Similarly for the quadrature results, the TFE 132 includes a receive data crossbar multiplexer 416, a differential combine 418 and an in-phase channel assembly block 420. The in-phase results and the quadrature results are combined in an I/Q combiner 422. The absolute value of the data is provided to a row and column normalizer 424 and then made available to the touch back end (TBE) 134. Similarly, the heatmap phase information from the I/Q combiner 422 is provided to the TBE 134 as well.

The TFE 132 further includes a scan controller 426, read control crossbar multiplexer 428 and transmit control crossbar multiplexer 430. Further, the TFE 132 includes a spectrum estimation processor 426 as will be described below in further detail. The spectrum estimation processor 426 provides a spectrum estimate to the TBE 134. The scan controller 426 receives high level control signals from the TBE 134 to control which columns are provided with transmit signals and which rows are sensed.

The receive data crossbar multiplexers 410, 416 and the receive control crossbar multiplexer 428 together for a receive crossbar multiplexer. These two multiplexers are used to logically remap the physical receive TFE channels by remapping both their control inputs and data outputs. As such, the control signals routed to both multiplexers may be identical, as the remapping performed by the receive data multiplexers 410, 416 and the receive control multiplexer 428 needs to be identical.

The receive data crossbar multiplexers 410, 416 sit between the output of the I/Q scan data path 408 and the heatmap assembly blocks 414, 420. The purpose of the receive data crossbar multiplexers 410, 416 is to enable the logical remapping of the receive channels. This in turn allows for logical remapping of the electrical connectors such as pins or balls which connect the integrated circuit including the controller 104 to other circuit components of the portable device 100. This will in turn enable greater flexibility in routing a printed circuit board from the integrated circuit including the controller 104 to the capacitive touch panel 102.

Since the I/Q scan data path 408 outputs complex results, the receive crossbar multiplexer may be able to route both the I and Q channels of the scan data path output. This can easily be achieved by instantiating two separate and identical crossbar multiplexers 410, 416. These two multiplexers will share the same control inputs.

The receive control crossbar multiplexer 428 sits between the scan controller 426 and the AFE 400. It is used to remap the per-channel receive control inputs going into the AFE 400. The structure of the receive control crossbar multiplexer 428 may be the same as for the receive data crossbar multiplexer 410, 416.

Since the Rx Ctrl crossbar is used in conjunction with the Rx Data crossbar to logically remap the RX channels, it may be programmed in conjunction with the Rx data crossbar. The programming of the receive control multiplexer 428 and the receive data crossbar multiplexers 410, 416 are not identical. Instead the programming may be configured so that the same AFE to controller channel mapping achieved in one multiplexer is implemented in the other.

The scan controller 426 forms the central controller that facilitates scanning of the capacitive touch panel 102 and processing of the output data in order to create the capacitive heatmap. The scan controller 426 operates in response to control signals from the TBE 134.

Scan Controller Modes of Operation

The scan controller 426 may support many different modes. A brief description of each mode is listed below. Switching between modes is typically performed at the request of the processor 122 (FIG. 1), with a few exceptions noted below.

Active scan mode is considered the standard mode of operation, where the controller 104 is actively scanning the capacitive touch panel 102 in order to measure the capacitive heatmap. Regardless of what form of panel scan is utilized, the scan controller426 steps through a sequence of step scans in order to complete a single frame scan.

In single-frame mode, the controller initiates one single frame scan at the request of the processor 122. After the scan is complete, the capacitive heatmap data is made available to the processor 122 and the scan controller 426 suspends further operation until additional instructions are received from the processor 426. This mode is especially useful in chip debugging.

In single-step mode, the controller initiates one single step scan at the request of the processor 122. After the scan is complete, the outputs of the scan data path 408 are made available to the processor 122 and the scan controller 426 suspends further operation until additional instructions are received from the processor 122. This mode is especially useful in chip testing and debugging.

Idle scan mode is a mode initiated by the processor 122 in order to run the controller 104 in a lower-performance mode. Typically, this mode will be selected when the controller 122 does not detect an active touch on the screen of the capacitive touch panel 102, but still wants reasonably fast response to a new touch. Therefore, the controller 122 is still active and capable of processing the heatmap data produced by the TFE 132.

The primary differences between active scan mode and idle scan mode are twofold. First, the frame rate in idle scan mode will typically be slower than that used in active scan mode. Duty cycling of the AFE 400 and other power reduction modes will be used in order to reduce total power consumption of the controller 104 during idle scan. Second, the length of time used to generate a single frame scan may be shorter in idle scan mode than in active scan mode. This may be achieved by either shortening the duration of a step scan or by performing fewer step scans per frame. Reducing total frame scan time can further reduce power at the expense of reduced capacitive heatmap signal to noise ratio (SNR).

Spectrum estimation mode is used to measure the interference and noise spectrum coupling into the receive channels. This measurement is then analyzed by the processor 122 to determine the appropriate transmit frequency and calculate the optimal filter coefficients for the filters within the scan data path 408. This mode is typically used with the Column Listening mode.

In spectrum estimation mode, most of the blocks of the TFE 132 in FIG. 4 are disabled. The scan controller 426, the AFE 400, and the spectrum estimation preprocessor 432 may be used. The transmit channel 402 of the AFE 400 is powered down, and the receive channel 406 of the AFE 400 records the background noise and interference signals that couple into the capacitive touch panel 102. The receive data from all of the channels of the AFE 400 are routed to the spectrum estimation preprocessor 432, which performs mathematical preprocessing on this data. The output of the spectrum estimation preprocessor 432 will be an N-point vector of 16-bit results, where N is approximately 200. The output of the spectrum estimation preprocessor 432 is handed off to the processor 122 for further analysis and determination of the appropriate transmit frequency to use. This process is described in greater detail below.

In addition to the functional modes described above, the controller 104 may have a set of sleep modes, where various functional blocks in the controller 104 are disabled and/or powered down completely.

A frame scan includes of a series of step scans. The structure of each step scan may be identical from step scan to the next within a given frame scan; however, the exact values of control data vary from step scan to step scan. Furthermore, the operation of a given frame scan may be determined by configuration parameters and may or may not affected by data values measured by the receive channel. One example of the frame scan logic that the controller circuit 104 may implement is shown below.

// Initialization
Set DDFS parameters;
Clear heatmap_memory;
// Step scan loop
For step_idx = 1 to num_step_scans {

// Configure circuits according to step_idx
Set scan_datapath_control to scan_datapath_parameters[step_idx];
Assert Rx_reset and wait TBD clock cycles;
Set AFE_control_inputs to AFE_parameters[step_idx];
Deassert Rx_reset and wait TBD clock cycles;
// Run step scan and collect data
Send start signal to DDFS and scan data path;
Wait for TBD clock cycles for step scan to complete;
Pass datapath_results[step_idx] to heatmap assembly block
// Incremental heatmap processing

} // step_idx loop

The incremental heatmap processing operation is described in greater detail below.

Multi-transmit Support and Block Stimulation of the Panel

In order to achieve improved SNR in the capacitive heatmap, the controller circuit 104 provides support for multi-transmit (multi-Tx) stimulation of the capacitive control panel 102. Multi-Tx simulation (or Multi-Tx) means that multiple rows of the panel are simultaneously stimulated with the transmit (Tx) signal, or a polarity-inverted version of the Tx signal, during each step scan. The number and polarity of the rows stimulated, may be controlled through control registers in the AFE 400. The number of rows simultaneously stimulated during multi-Tx is defined as a parameter Nₘᵤₗₜᵢ may be a constant value from step-to-step within a given frame and also from frame-to-frame.

If Nₘᵤₗₜᵢ rows are simultaneously stimulated during a step scan, it will take at least Nₘᵤₗₜᵢ step scans to resolve all the pixel capacitances being stimulated. Each receiver has Nₘᵤₗₜᵢ capacitances being stimulated during a scan step. Hence there are Nₘᵤₗₜᵢ unknown capacitances, requiring at least Nₘᵤₗₜᵢ measurements to resolve these values. During each of these Nₘᵤₗₜᵢ steps, the polarity control of the Tx rows will be modulated by a set of Hadamard sequences. Once this set of Nₘᵤₗₜᵢ (or more) step scans is complete, the next set of Nₘᵤₗₜᵢ rows can be stimulated in the same fashion, as Nₘᵤₗₜᵢ will almost always be less than the number of actual rows in the capacitive touch panel 102.

In this way, the processing of the entire capacitive touch panel 102 occurs in blocks, where Nₘᵤₗₜᵢ rows of pixels are resolved during one batch of step scans, and then the next Nₘᵤₗₜᵢ rows of pixels are resolved in the next batch of step scans, until all the panel rows are fully resolved.

In most scenarios, the number of panel rows will not be an exact multiple of Nₘᵤₗₜᵢ. In these situations, the number of rows scanned during the final block of rows will be less than Nₘᵤₗₜᵢ. However, Nₘᵤₗₜᵢ scan steps may be performed on these remaining rows, using specified non-square Hadamard matrices.

Differential Scan Mode

Differential scan mode is an enhancement to normal scanning mode, whereby the frame scan operation is modified to exploit the correlation of the interference signal received across adjacent receive channels. In this mode, the normal frame scan methodology is performed; however the number of step scans used to assemble a single frame is doubled. Conceptually, each step scan in the scan sequence becomes two step scans: the first is a single-ended or normal step scan with the default values for the AFE control registers, and the second is a differential step scan.

Given N_{RX} receive channels, the differential scan mode yields a total of 2N_{RX} receiver measurements per aggregate scan step. (e.g. N_{RX} single-ended measurements and N_{RX} differential measurements.) These 2N_{RX} measurements are recombined and collapsed into N_{RX} normal measurements in the Differential Combiner block 412, 418 shown in FIG. 4.

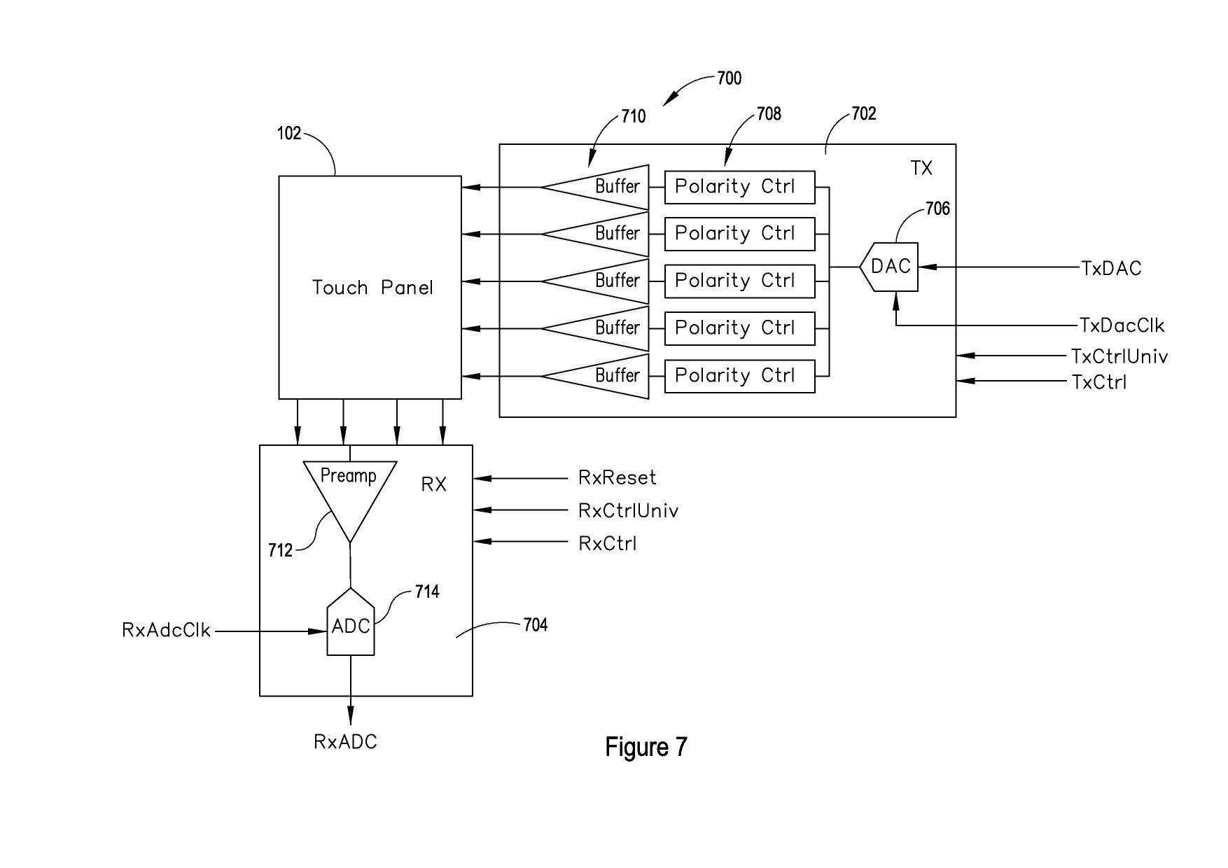

FIG. 7 shows a high-level architecture 700 of the analog front end. The architecture 700 includes a transmit channel 702 providing signals to columns of the capacitive touch panel 102 and a receive channel 704 sensing signals from the capacitive touch panel 102. The transmit channel 702 includes a digital to analog converter 706, polarity control circuits 708 and buffers 710. The receive channel 704 includes a pre-amplifier 712 and analog to digital converter 714.

All transmit channels may be driven by a shared transmit data signal labeled TxDaC in FIG. 7. Each physical transmit channel may also receive a common transmit digital to analog converter clock signal, labeled TxDacClk, to drive the transmit digital to analog converter 706. The clock signal will come directly from a frequency locked loop block within the TFE 132, and this clock signal will also be routed to the digital portion of the TFE 132.

Each physical transmit channel may also have its own set of channel-specific TxCtrl bits that appropriately control various parameters of the transmit channel, such as enable/disable, polarity control, and gain/phase control). These TxCtrl bits are not updated at the TxDacClk rate, but rather are updated between subsequent step scans during the frame scan operation.

A control signal controls the transmit polarity of each of the 48 transmit channels. As will be described in greater detail below, the polarity of the transmit outputs may be modulated in an orthogonal sequence, with each transmit output having a fixed polarity during each scan step during a frame scan.

All receive channels will receive a set of common clock signals. These clock signals are provided directly from a frequency locked loop block within the TFE 132, and this clock signal is also routed to the digital portion of the TFE 132. The clock signals routed to the RX channels include the signal RxADCCIk which drives the RxADC. A typical clock frequency for this signal is 48 MHz.

Each physical receive channel will also have its own set of channel-specific receive control bits, labeled RxCtrl in FIG. 7, that appropriately control various parameters of the receive channel, such as enable/disable and gain control. These receive control bits are updated between subsequent step scans during the frame scan operation.

Additionally, there may be a shared set of control settings, labelled RxCtrlUniv in FIG. 7, that will control all receive channels simultaneously. These registers are primarily composed of generic control bits that will remain constant for a given implementation of the controller 104.

There are also one or more reset lines labeled RxReset that are common to all reset channels. These reset lines may be asserted in a repeatable fashion prior to each scan step.

Waveform Generation

The waveform generation block (WGB) 404 in FIG. 4 generates the transmit waveform for the TX channels 402. The WGB 404 generates a digital sine wave. Additionally, WGB 404 may generate other simple periodic waveforms; such as square waves having edges with programmable rise and fall times.

The primary output of the WGB 404 is the data input to the transmit channels 402 labelled TxDAC in FIG. 4. The WGB 404 receives as input signals a clock signal labelled TxDacClk and a signal labelled Start in FIG. 4. Upon receiving the Start signal from the scan controller 426, the WGB 404 begins producing digital waveforms for the duration of a single step scan. At the conclusion of the step scan, the WGB 404 ceases operation and waits for the next start signal from the scan controller 426.

The WGB 404 may have some amount of amplitude control, but the WGB 404 will typically be operated at maximum output amplitude. Therefore, the performance requirements listed below only need to be met at max output amplitude. All signal outputs may be in two's complement format. The WGB 404 may also provide arbitrary sine/cosine calculation capabilities for the scan data path 408 and spectrum estimation preprocessor 432.

The following table lists typical performance for the WGB 404.

| Specification | Min | Nom | Max | Comment |
|---|---|---|---|---|
| Clock rate | | 8 MHz | | Will operate at |
| | | | | TxDacClk rate |
| Output frequency | 0 Hz | — | 2 MHz | |
| Frequency ctrl resolution | — | 15 bits | — | Desired resolution |
| | | | | of ^{~}61 Hz. Can be |
| | | | | different. |
| # of output bits | — | 8 | — | |
| Output amplitude | 50% | 100% | 100% | |
| | amplitude | amplitude | amplitude | |
| Amplitude ctrl resolution | — | 7 bits | — | Corresponds to 1% |
| | | | | stepsize in amplitude |
| | | | | control. |
| DC bias control | 0 | 0 | 0 | All outputs should be |
| | | | | balanced around 0 |
| Output THD | | | −40 dBFs | Sine wave mode only |
| Rise/fall time | 1 calk | — | 256 calk | Square-wave mode |
| | cycle @ | | cycles @ | only. Independent |
| | 8 MHz | | 8 MHz | control of rise time vs. |
| | | | | fall time NOT required. |

In FIG. 4, the differential combiner blocks 412, 410 provide the capability to operate in differential mode, where the receive channels 406 alternate step scans between single-ended measurements and differential measurements. The purpose of the differential combiner blocks 412, 418 is to combine the N_{RX} single-ended measurements and (N_{RX}−1) differential measurements into a single set of N_{RX} final results for use in the heatmap assembly blocks 414, 420 that follow.

The differential combiner blocks 412, 418 are akin to a spatial filter. Let the vector, c, be an Nᵣₓ-by-1 vector of the capacitances to estimate. In differential mode, you have a vector, s, of single-ended measurements and a vector, d, of differential measurements. Hence, an estimate of c, called cₑₛₜ, is sought by optimally recombining s and d. Determining the optimal recombination requires substantial computation, but simulations have shown that the following recombination scheme works to within roughly 0.5 dB of optimal performance over the expected range of operating conditions:

c_{est,n}=a₁·sₙ₋₂+a₂·sₙ₋₁+a₃sₙ+a₂·sₙ₊₁+a₁·sₙ₊₂+b₁·dₙ₋₁+b₂·dₙ·b₂·dₙ₊₁−b₁·dₙ₊₂

where the subscript n indicates result from the n^{th} receiver channel, and 0≦n≦N_{RX}−1.

Furthermore, the coefficients are subject to the following constraints:

0≦a₁,a₂,a₃≦1

a₃=1−2a₁−2a₂

b₁=a₁

b₂=a₁+a₂

Given these constraints, it can be observed that the math operation listed above can be collapsed into two multiplication operations:

c_{est,n}=sₙ+a₁·(sₙ₋₂−2sₙ+sₙ₊₂+dₙ₋₁+dₙ−dₙ₊₁−dₙ₊₂)+a₂·(sₙ₋₁−2sₙ+sₙ₊₁+dₙ−dₙ₊₁)

The equations above assume that the data exists for 2 receivers on either side of the nth receiver. (e.g. 2≦n≦N_{RX}−3) Therefore, the equations above may be modified for the two outer edge receive channels on either side. The modifications are quite simple. First, replace any non-existent sₖ term with the nearest neighboring sⱼ term that does exist. Second, replace any non-existent dₖ term with 0. Putting these rules together and expressing the mathematics in matrix form, we get:

$${c}_{est} = [ \begin{matrix}{a}_{1} + {a}_{2} + {a}_{3} & {a}_{2} & {a}_{1} & 0 & 0 & - {b}_{2} & - {b}_{1} & 0 & 0 \\ {a}_{1} + {a}_{2} & {a}_{3} & {a}_{2} & {a}_{1} & 0 & {b}_{2} & - {b}_{2} & - {b}_{1} & 0 \\ {a}_{1} & {a}_{2} & {a}_{3} & {a}_{2} & {a}_{1} & {b}_{1} & {b}_{2} & - {b}_{2} & - {b}_{1} \\ ⋮ & ⋮ & ⋮ & ⋮ & ⋮ & ⋮ & ⋮ & ⋮ & ⋮ \\ {a}_{1} & {a}_{2} & {a}_{3} & {a}_{2} & {a}_{1} & {b}_{1} & {b}_{2} & - {b}_{2} & - {b}_{1} \\ 0 & {a}_{1} & {a}_{2} & {a}_{3} & {a}_{2} + {a}_{1} & 0 & {b}_{1} & {b}_{2} & - {b}_{2} \\ 0 & 0 & {a}_{1} & {a}_{2} & {a}_{3} + {a}_{2} + {a}_{1} & 0 & 0 & {b}_{1} & {b}_{2}\end{matrix} ] \cdot [ \begin{matrix}{s}_{0} \\ ⋮ \\ {s}_{{N}_{Rx} - 1} \\ {d}_{1} \\ ⋮ \\ {d}_{{N}_{RX} - 1}\end{matrix} ]$$

Lastly, while the optimal values of {a1, a2, a3, b1, b2} are dependent upon the precise noise and interference environment, it has been found that the following values for these parameters operate near optimal performance for the expected range of operating environments:

a₁=⅛

a₂= 7/32

a₃= 5/16

b₁=⅛·k_{ADC}

b₂= 11/32·k_{ADC}

The parameters b₁ and b₂ above are dependent upon another parameter, k_{ADC}. The new parameter, k_{ADC}, is dependent upon the value of receive channel analog to digital converter gain (Rx_AdcGain) used during the differential measurement step, as detailed in the table below:

| Rx_AdcGain<1:0> used during | |
|---|---|
| differential measurement step | k_{ADC} |
| 00 | 1 |
| 01 | ¾ |
| 10 | ½ |
| 11 | ⅜ |

These a and b coefficients should be programmable by a control source such as firmware that is part of the controller 104, but the default values should be those listed above. The table below indicates the suggested bit width for each coefficient:

| Coefficient | Bit width |
|---|---|
| a₁ | 5 |
| a₂ | 5 |
| a₃ | 5 |
| b₁ | 6 |
| b₂ | 8 |

The heatmap assembly blocks (HAB) 414, 420 take the step scan outputs from the scan data path 408 or differential combiners 412, 418, if used, and assembles the complete capacitive heatmap that is the major output of the frame scan operation. In order to do so, it may mathematically combine all of the step scan outputs in the appropriate manner to create estimates of the capacitance values of the individual capacitive pixels in the capacitive touch panel 102.

As shown in FIG. 4, there are two separate and identical instantiations of the HAB. A first HAB 414 is for the I-channel data and a second HAB 420 is for the Q-channel data. Each HAB 414, 418 operates on the either the I-channel or Q-channel data in order to create either an I-channel or a Q-channel capacitive heatmap.

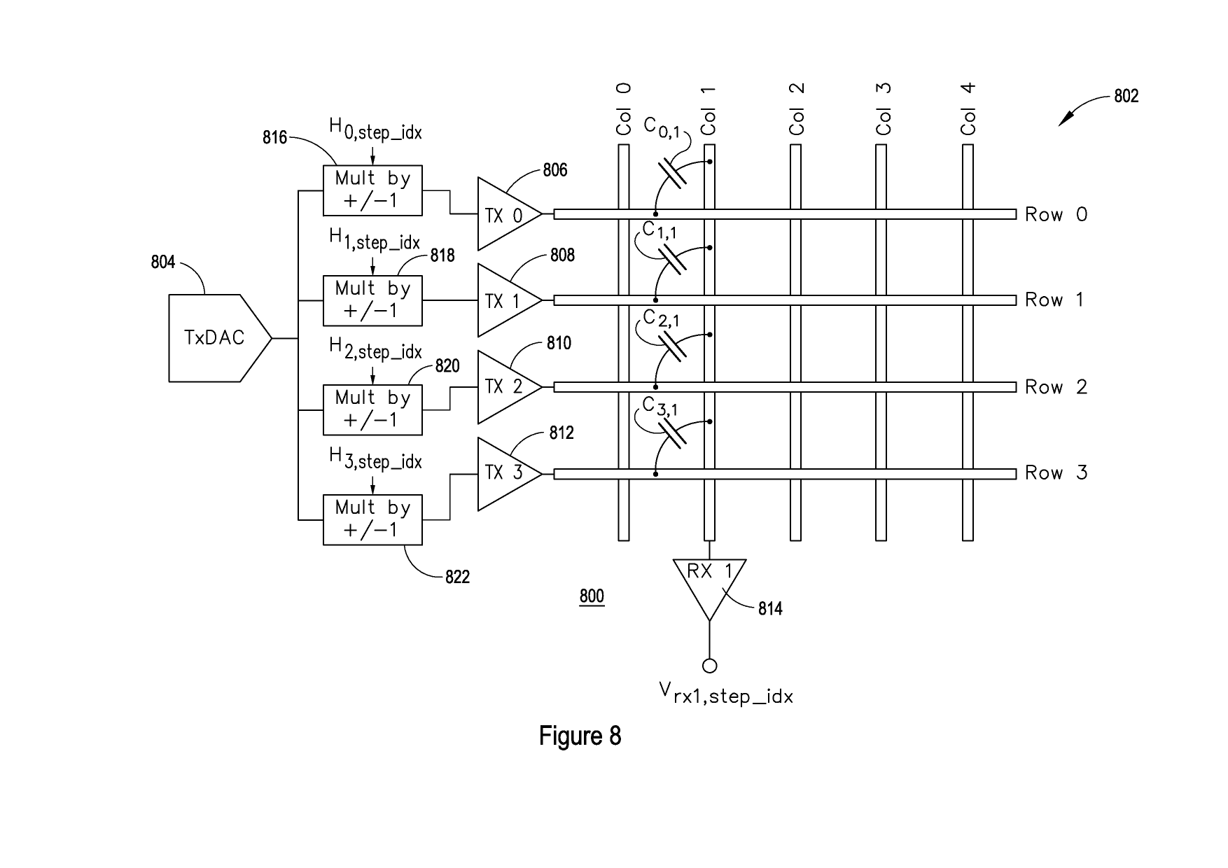

In order to demonstrate the mathematics that may apply for heatmap assembly, an example 4×5 capacitive touch panel 800 is illustrated in FIG. 8. In this example, only the capacitive pixels in column 1 are analyzed, but the same principle can be easily extended to each of the five columns in the example capacitive touch panel 800. In particular, the output of receive column j is only affected by capacitance pixels in column j.

The example capacitive touch panel 800 includes a touch panel 802, a transmit digital to analog converter (TxDAC) 804, transmit buffers 806, 808, 810, 812, and a receive analog to digital converter 814. The transmit buffers 806, 808, 810, 812 each have an associated multiplier 816, 818, 820 822, respectively. The multipliers 816, 818, 820 822 operate to multiply the applied signal from the TxDAC by either +1 or −1.

In the example of FIG. 8, a single TxDAC waveform is sent to all four transmit buffers 806, 808, 810, 812. However, each buffer multiplies this waveform by either +1 or −1 before transmitting it onto the row of the touch panel 802. For a given step scan (indicated by the subscript “step_idx”), each value of Hi,step_idx is held constant. But for subsequent step scans in the scan sequence, these values may change. Therefore, at a given step index, the voltage received at m^{th} Rx channel is:

$${V}_{step\_idx , m} = {V}_{TX} \cdot {RxGain}_{m} {\sum }_{n = 0}^{NumRows - 1} {H}_{n , step\_idx} \cdot {C}_{n , m}$$

where V_{TX} is the amplitude of the transmit signal and RxGainₘ is the gain of the receive channel m. In order to simplify the analysis, these two parameters are assumed to be equal to 1 and ignored in subsequent calculations.

As can be seen by this equation above, Vₛₜₑₚ_{_{—}}_{idx,m} is based on NumRows (e.g. 4) unknown values, C_{n,m}, with n=0 to 3 in this example. Therefore, if four independent step scans are performed with four independent H sequences applied to the four transmit buffers 806, 808, 810, 812, the relationship between V and C can be inverted in order to estimate the C values from V. In matrix form, this can be written:

$${V}_{m} = H \cdot {C}_{m}$$

$${V}_{m} = [ \begin{matrix}{V}_{0 , m} \\ {V}_{1 , m} \\ ⋮ \\ {V}_{NumSteps - 1 , m}\end{matrix} ]$$

$${H}^{NumSteps , NumRows} = [ \begin{matrix}{H}_{0 , 0} & … & {H}_{0 , NumRows - 1} \\ ⋮ & ⋱ & ⋮ \\ {H}_{NumSteps - 1 , 0} & … & {H}_{NumSteps - 1 , NumRows - 1}\end{matrix} ]$$

$${C}_{m} = [ \begin{matrix}{C}_{0 , m} \\ {C}_{1 , m} \\ ⋮ \\ {C}_{NumRows - 1 , m}\end{matrix} ]$$

In this formulation, the column vector Cₘ represents the capacitance of the capacitive pixels in the m^{th} column of the capacitive touch panel. H is a NumSteps×NumRows matrix, where the n^{th} column of the H-matrix represents the multiplicative sequence applied to the n^{th} transmit row. The optional superscript of H indicates the dimensions of the H matrix. Vₘ is a column vector, where the n^{th} entry in the matrix is the n^{th} step scan output of m^{th} RX channel.

In the present application, H is a special form of matrix, called a modified Hadamard matrix. These matrices have the property that:

H^{T}·H=NumSteps·I

where I is the NumRows×NumRows identity matrix, and H^{T} is the transpose of H.

Given the formulation above, and the properties of the H-matrix, the relationship from Cₘ to Vₘ can be inverted in order to extract out the values of the Cₘ vector from the Vₘ measurements. Using the terminology defined above:

$${C}_{m} = \frac{1}{NumSteps} {H}^{T} \cdot {V}_{m}$$

In the example above, the panel had four rows and the value of NumSteps (equivalently Nₘᵤₗₜᵢ) was also set to four. Therefore, all panel rows were stimulated during every step scan. In general, the number of panel rows will be larger than the value of Nₘᵤₗₜᵢ. In that case, the panel stimulation is broken up into blocks. During each block of Nₘᵤₗₜᵢ step scans, Nₘᵤₗₜᵢ adjacent rows are stimulated with the Hadamard polarity sequencing described above.

The heatmap assembly block 414, 420 works on each block of Nₘᵤₗₜᵢ scans independently in order to create the complete heatmap output. For instance, if there were twelve panel rows and Nₘᵤₗₜᵢ were set to four, then the first four step scans would be used to stimulate and assemble the first four rows of the capacitive heatmap; the next four step scans would be for the fifth through eighth panel rows; and the last four step scans would be for the ninth through twelfth rows. Therefore, for each block of Nₘᵤₗₜᵢ rows, the heatmap assembly block operates in the exact same manner as defined above. However, the outputs of the HAB 414, 420 are mapped to the subsequent rows in the complete capacitive heatmap.

The heatmap assembly block 414, 420 is capable of assembling a 32-column-wide heatmap, as there are a total of 32 receiver channels implemented in one embodiment. However, in many cases, the capacitive touch panel used will not have 32 columns, and hence not all 32 receive channels are used.

Mathematical Extensions for Asymmetric Panel Scanning

As described above, the controller 104 preferably has the capability to perform asymmetric panel scans, where the firmware supporting operation of the controller 104 has the capability to define the number of times each row is to be scanned. Given the formulation for asymmetric panel scanning outlined above, the changes to the heatmap assembly operation in order to support this feature are minimal.

As described above, the heatmap is assembled in a blocks of Nₘᵤₗₜᵢ rows. In asymmetric scanning, Nₘᵤₗₜᵢ can vary on a block-by-block basis. Therefore, the old equation of:

$${C}_{m} = \frac{1}{NumSteps} {H}^{T} \cdot {V}_{m}$$

is still valid. However, with asymmetric scanning, the dimensions of C, V, and H and the value of NumSteps change on a block-by-block basis.

The I/Q combiner 422 shown in 4 is used to combine the I- and Q-channel heatmaps into a single heatmap. The primary output of the I/Q combiner 422 is a heatmap of the magnitude (e.g. Sqrt[I²+Q²]). This is the heatmap that is handed off to the touch back end 134.

The row/column normalizer 424 shown in FIG. 4 is used to calibrate out any row-dependent or column-dependent variation in the panel response. The row/column normalizer 424 has two static control input vectors, identified as RowFac and ColFac. RowFac is an Nrow-by-1 vector, where each entry is 1.4 unsigned number (e.g. LSB=1/16. Range is 0 to 31/16). ColFac is an Ncol-by-1 vector, where each entry has the same dimensions as RowFac.

If the input data to the Row/Column Normalizer block is labeled as HeatmapIn(m,n), where m is the row index and n is the column index, the output of the block should be:

HeatmapOut(m,n)=HeatmapIn(m,n)·RowFac(m)·ColFac(n)

In one embodiment, the controller 104 has the capability to allow RowFac and ColFac to be defined either by OTP bits or by a firmware configuration file. The OTP settings will be used if the manufacturing flow allows for per-module calibration, thus enabling the capability to tune the controller 104 on a panel-by-panel basis. If RowFac and ColFac can only be tuned on a per-platform basis, then the settings from a firmware configuration file will be used instead.

Spectrum Estimation

The spectrum estimation preprocessor 432 operates to determine the background levels of interference that couple into the receive channels 406 so that the controller 104 may appropriately select transmit frequencies that are relatively quiet or interference free.

The spectrum estimation preprocessor 432 will generally only be used during SEM mode, so it is not part of the standard panel-scan methodology. Instead, the spectrum estimation preprocessor 432 will be used when conditions indicate that SEM should be invoked. At other times, the spectrum estimation preprocessor 432 can be powered down.

Baseline Tracking and Removal Filter

A touch event should be reported when the measured capacitance of a capacitive pixel (or group of pixels) changes by a large enough amount in a short enough period of time. However, due to slow environmental shifts in temperature, humidity or causes of drift, the absolute capacitance of a pixel (or group of pixels) can change substantially at a much slower rate. In order to discriminate changes in pixel capacitance due to a touch event from changes due to environmental drift, a baseline tracking filter can be implemented to track the changes in the baseline (e.g. “untouched” or “ambient” value of the capacitance), and simple subtraction of the baseline capacitance from the input capacitance will yield the change in capacitance due to the touch event.

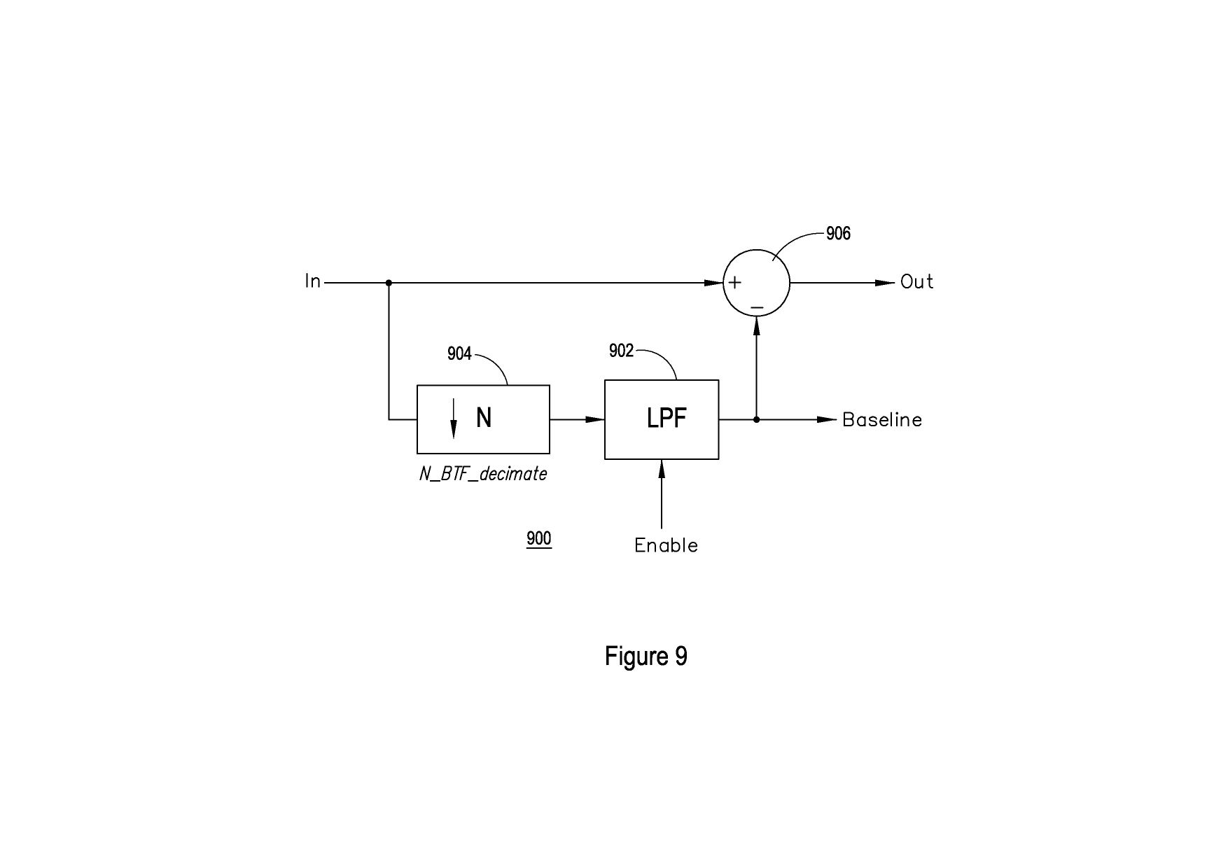

FIG. 9 illustrates a baseline tracking filter 900. The filter 900 includes a low-pass filter (LPF) 902, a decimator 904 and a combiner 906. The input signal to the filter 900 is provided to the combiner 906 and the decimator 904. The output signal of the decimator is provided to the input of the LPF 902. The output of the LPF 902 is combined with the input signal at the combiner 906. The LPF 902 has an enable input for controlling operation of the filter 900.

The LPF 902 in the baseline tracking filter 900 is used to improve the estimate of the baseline capacitance value. One embodiment uses a simple finite impulse response (FIR) moving average filter of length N (aka “comb filter”), such as:

$${H}_{N} ( z ) = \frac{1}{N} \cdot \frac{1 - {z}^{- N}}{1 - {z}^{- 1}} = \frac{1}{N} \cdot {\sum }_{n = 0}^{N - 1} {z}^{- n}$$

Another embodiment a 1-tap infinite impulse response (IIR) filter, also referred to as a modified moving average, with response:

$${H}_{k} ( z ) = \frac{\frac{1}{k}}{1 - ( 1 - \frac{1}{k} ) {z}^{- 1}}$$

The FIR embodiment of the filter 902 may be used upon startup and recalibration of the baseline value, as it can quickly acquire and track the baseline value. The IIR embodiment of the filter 902 should be used once the baseline value is acquired, as it can be a very computationally efficient means to implement a low-pass filter, particularly if k is chosen to be a power of 2. By increasing the value of k, one can set change the signal bandwidth of the filter to arbitrarily small values with minimal increase in computational complexity.

Filter 900 has two outputs, labeled “Out” and “Baseline” in FIG. 9. The Baseline output is the estimate of the current baseline (aka “ambient” or “untouched”) capacitance of the particular panel pixel(s) being scanned, and the “Out” output is the baseline-corrected value of that capacitance measurement. The “Out” value is what should be used in the subsequent touch-detection logic.

The LPF 902 in FIG. 9 has an enable signal in order to shut down the LPF 902 when a touch event is detected. This is provided so that the baseline output is not corrupted by spurious data, most likely from a touch event. If the enable signal is low, the LPF 902 will hold its previous output without updating its output with the incoming data, effectively ignoring the incoming data. Once the enable signal is high, the LPF 902 will continue to update its output with the incoming data. Logic for generating the enable signal is detailed in the following equation:

Enable=(Out≦PosLPFThresh)&&(Out≧NegLPFThresh)

where PosLPFThresh and NegLPFThresh are configurable parameters.

In a mutual-capacitance scan mode, where a touch event causes a reduction in the input data, the NegLPFThresh should be set to k_{T}*TouchThresh, where 0<k_{T}<1 and TouchThresh is the touch-detection threshold defined below. These may both be programmable parameters. In a mutual-capacitance scan mode, there is no expected physical mechanism that would cause the input data to exhibit a positive transient. Therefore, PosLPFThresh may be a programmable parameter used to filter out spurious data, should an unexpected positive transient occur.

Programmable Update Rate

The timescale of most baseline drift phenomena will be far slower than the frame rate of the touch panel scan. For instance, observed baseline drift devices had timescales on the order of 1 hour or longer, whereas the frame rate of a current device may be on the order of 200 frames/second. Therefore, in order to reduce the computation for baseline tracking, the controller circuit 104 shall have the capability to scale the update rate of the baseline tracking filter 900. The device may do this by using the decimator 904 to decimate the data fed to the filter 900, so that the filter 900 only operates on every N_BTF_decimate frames of heatmap data, where N_BTF_decimate is a programmable parameter. Therefore, the Baseline signal in FIG. 9 will update at this slower rate. However, the baseline corrected output signal (“Out” in FIG. 9) may be calculated for every frame.

Baseline tracking needs to exercise special care when spectrum estimation mode (SEM) is invoked. SEM may cause a configuration change in the analog front end which in turn will alter the gain in the transfer function (e.g. from capacitance values to codes) of the touch front end. This, in turn, may cause abrupt changes in the capacitive heatmap to occur that could be accidentally interpreted as touch events.

A touch event is detected when the baseline-corrected output exhibits a significant negative shift. The shift in this output may be larger than a programmable parameter, called TouchThresh. Furthermore, since the controller circuit 104 may scan a panel at upwards of 200 Hz and a human finger or metal stylus moves at a much slower timescale, a programmable amount of debounce, dubbed TouchDebounce, should also be included. Therefore, before a touch is recognized, the output of the baseline filter may be more negative than TouchThresh for at least TouchDebounce frames. It is likely that TouchDebounce will be a small value, in order that the total touch response time is faster than 10 ms.

Heatmap Noise Estimation

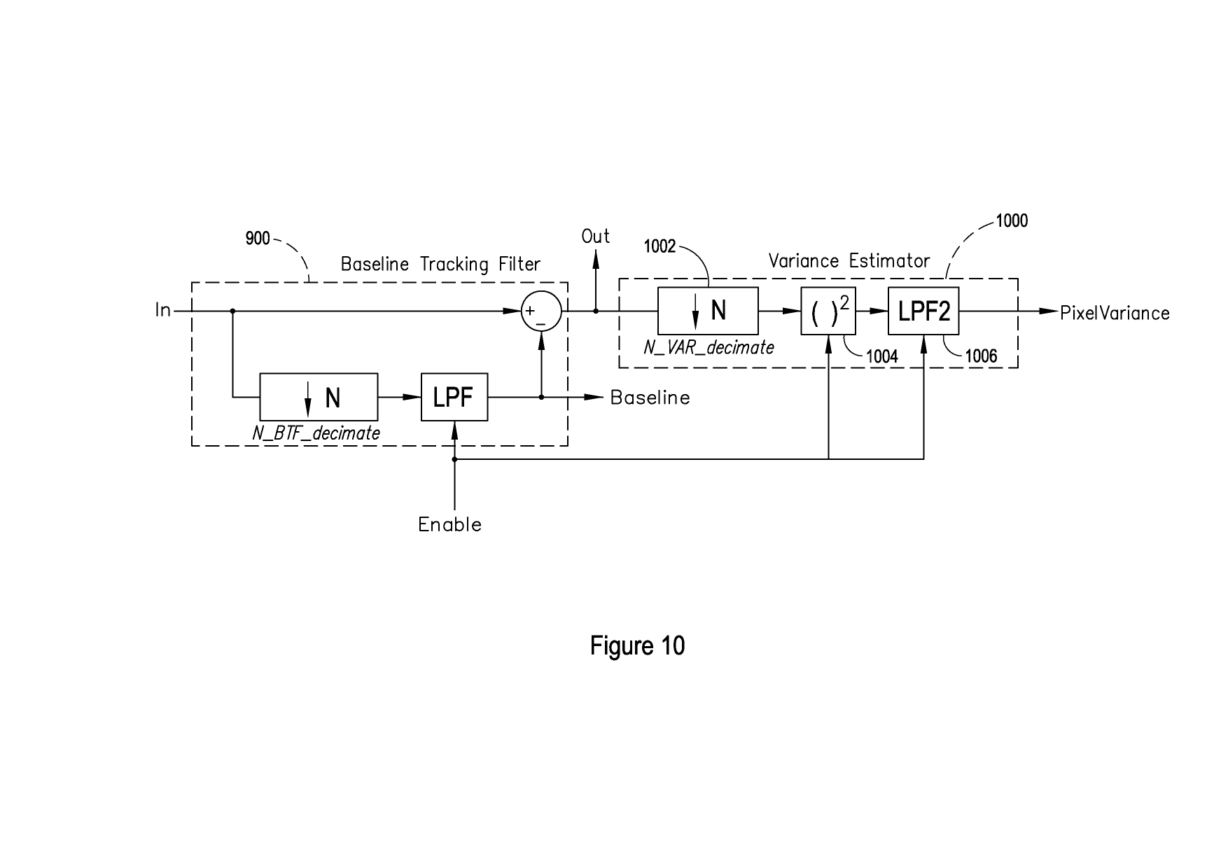

The touch back end 134 may use an estimate of the noise level in the capacitive touch panel 102 in order to properly threshold the touch blobs during the detection process. The noise level can be detected by observing noise at the output of the baseline tracking filter as shown in FIG. 10. FIG. 10 shows a first variance estimator 1000 in conjunction with the baseline tracking filter 900 of FIG. 9. In FIG. 10, the baseline tracking filter 900 has its Out output coupled to an input of the variance estimator 1000. The variance estimator 1000 includes a decimator 1002, a signal squarer 1004 and a low-pass filter 1006. The variance estimator 1000 in this embodiment is simply a mean-square estimator, as the output of the baseline tracking filter 900 is zero-mean. Hence the mean-square is equal to the variance.

In order to lower the computational requirements for the variance estimator 900, the data entering the variance estimator can be decimated in the decimator 1002 by the factor, N_VAR_decimate. The low-pass filter 1006 in the variance estimator 1000 may either be a comb-filter or a modified-moving-average filter. The length of the response of the filter 1006 may be a programmable parameter, averaging data over as many as 100 or more frames. In order to lower memory requirements, the MMA filter may be preferred.

As with the baseline tracking filter 900, the LPF 1006 in the variance estimator 1000 has an input for an enable signal. The enable signal is low when the pixel in question is being touched. Otherwise, the variance estimate will be corrupted by the touch signal. When the enable signal is low, the LPF 1006 should retain state, effectively ignoring the data coming into the variance estimator 1000.

The output of the variance estimator 1000 is the variance of one single pixel in the capacitive touch panel 102. Therefore, this provides an independent variance estimate of each pixel in the panel. To get an estimate of the variance across the panel 102, the controller circuit 104 may average the per-pixel variances across the entire frame.

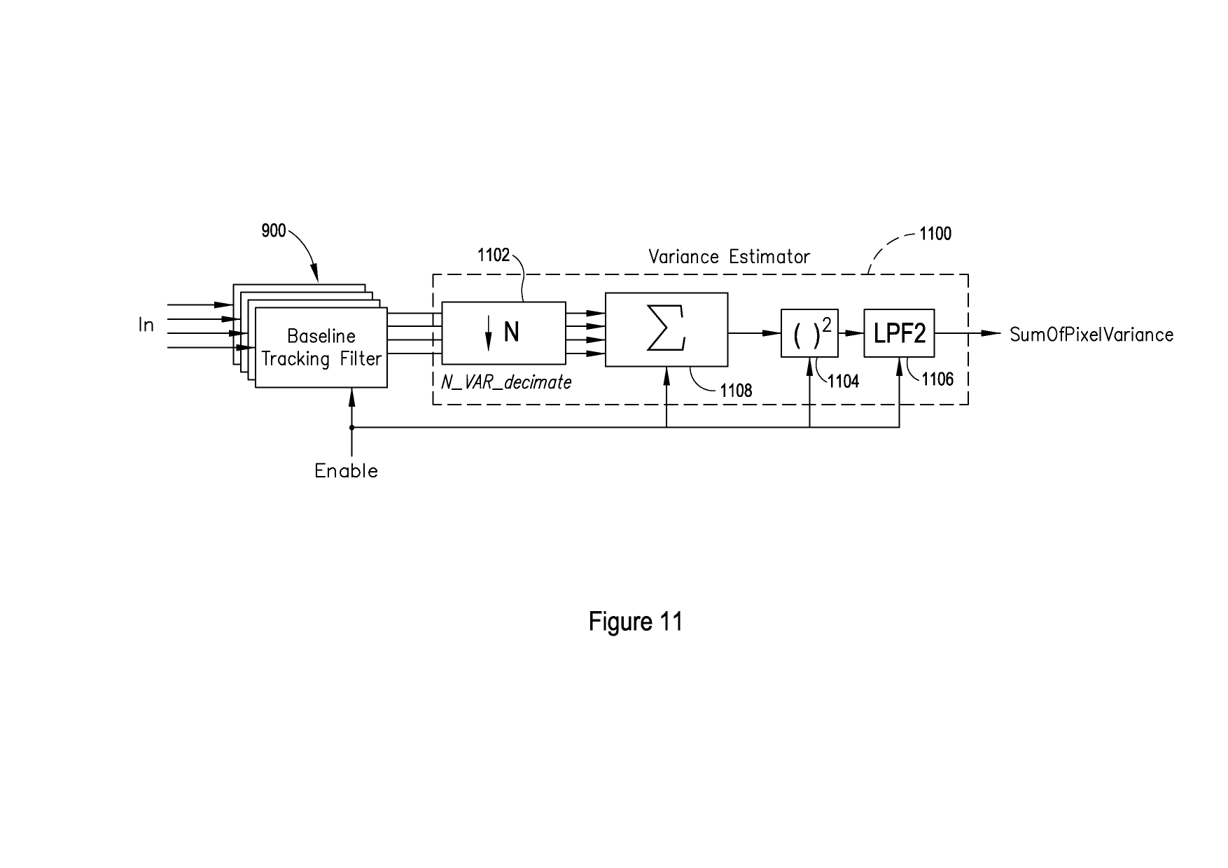

Alternately, if only a single per-frame variance estimate is needed, the controller circuit 104 can follow the approach shown in FIG. 10. FIG. 11 shows a second variance estimator 1100 in conjunction with the baseline tracking filter 900 of FIG. 9. In FIG. 11, all the per-pixel baseline tracking filters are grouped as baseline tracking filters 900, on the left in the figure. All the baseline-corrected outputs from the baseline tracking filters 900 are passed to the variance estimator 1100.

Like the variance estimator 1000 of FIG. 10, the variance estimator 1100 includes a decimator 1102, a signal squarer 1104 and a low-pass filter 1106. The variance estimator 1100 further includes a summer 1108. The variance estimator 1100 combines the outputs of the baseline tracking filters 900 into a single value by summing the baseline-corrected outputs across the entire frame in the summer 1108. This averaged value is then passed to the same square-and-filter estimator that was described above, formed by the signal squarer 1104 and the low-pass filter 1106. Assuming that the noise is uncorrelated from pixel-to-pixel, the output of the variance estimator 1100 is equal to the sum of all the pixel variances reported by the block diagram in FIG. 10. In order to generate the average pixel variance across the panel, this result may be divided by the total number of pixels in the capacitive touch panel 102. To generate an estimate of the standard-deviation of the noise, the controller circuitry 104 may take the square root of the variance.

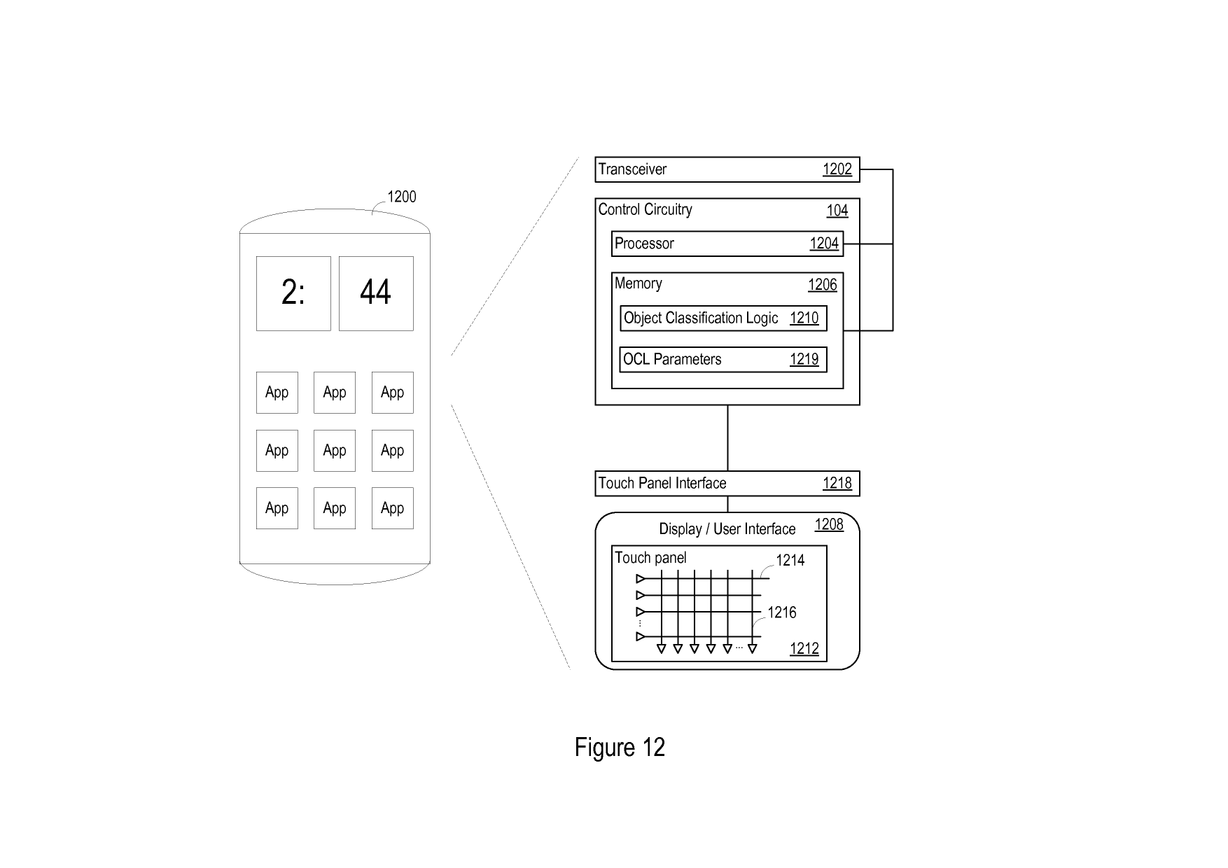

In one implementation, the controller circuit 104 implements object classification of objects interacting with the touch panel. One specific example is described with reference to FIG. 12 in the context of a smartphone 1200 (although the techniques may be implemented in any device with a touch panel). The smartphone 1200 may include a transceiver 1202 and the control circuitry 104, including one or more processors 1204, a memory 1206, and a user interface 1208. The transceiver 1202 may be wireless transceiver, and the transmitted and received signals may adhere to any of a diverse array of formats, protocols, modulations, frequency channels, bit rates, and encodings Thus, the transceiver 1202 may support the 802.11a/b/g/n/ac standards, the 60 GHz WiGig/802.11TGad specification, Bluetooth, Global System for Mobile communications (GSM), Time Division Multiple Access (TDMA), Frequency Division Multiple Access (FDMA), Code Division Multiple Access (CDMA), or other wireless access techniques or protocols.

The processor 1204 executes the object classification logic (“OCL”) 1210 according to the OCL parameters 1219. The OCL 1210 may be part of an operating system, an application program, firmware, or other logic. The user interface 1208 includes a capacitive touch panel 1212 which is divided into a grid of rows 1214 and columns 1216 (and as also shown, for example, in FIG. 3). For the sake of illustration, the transmitters are connected to the rows 1214 and the receivers are connected to the columns 1216, however, that arrangement may be reversed. At each intersection of row and column (referred to as a pixel), there is a capacitance that is impacted by the presence or absence of a finger, stylus, or any other conductive touching object. The capacitance value at each pixel provides the “heat map” of capacitance across the touch panel 1212, and may be envisioned as a contour map of the touch panel 1212 in which the values are the capacitance values at each pixel.

Traditionally, to obtain the capacitance value at each pixel, each row of the touch panel 1212 is sequentially energized (one at a time) by its transmitter, and the receivers across the row, for each column, determine the capacitance values for the pixels in the energized row. Thus, the touch panel 1212 is scanned one row at a time. Accordingly, if there are ‘n’ rows, it takes ‘n’ scans to image the entire touch panel 1212. Assuming for the sake of illustration that there is a one millisecond time window in which to image the entire touch panel 1212 (for a frame rate of 1000 frames per second), and there are 10 rows, then each row may get energy for 1/10th of a millisecond. If a faster frame rate is desired, then the duration of each row scan may be reduced to less than 1/10th of a millisecond.

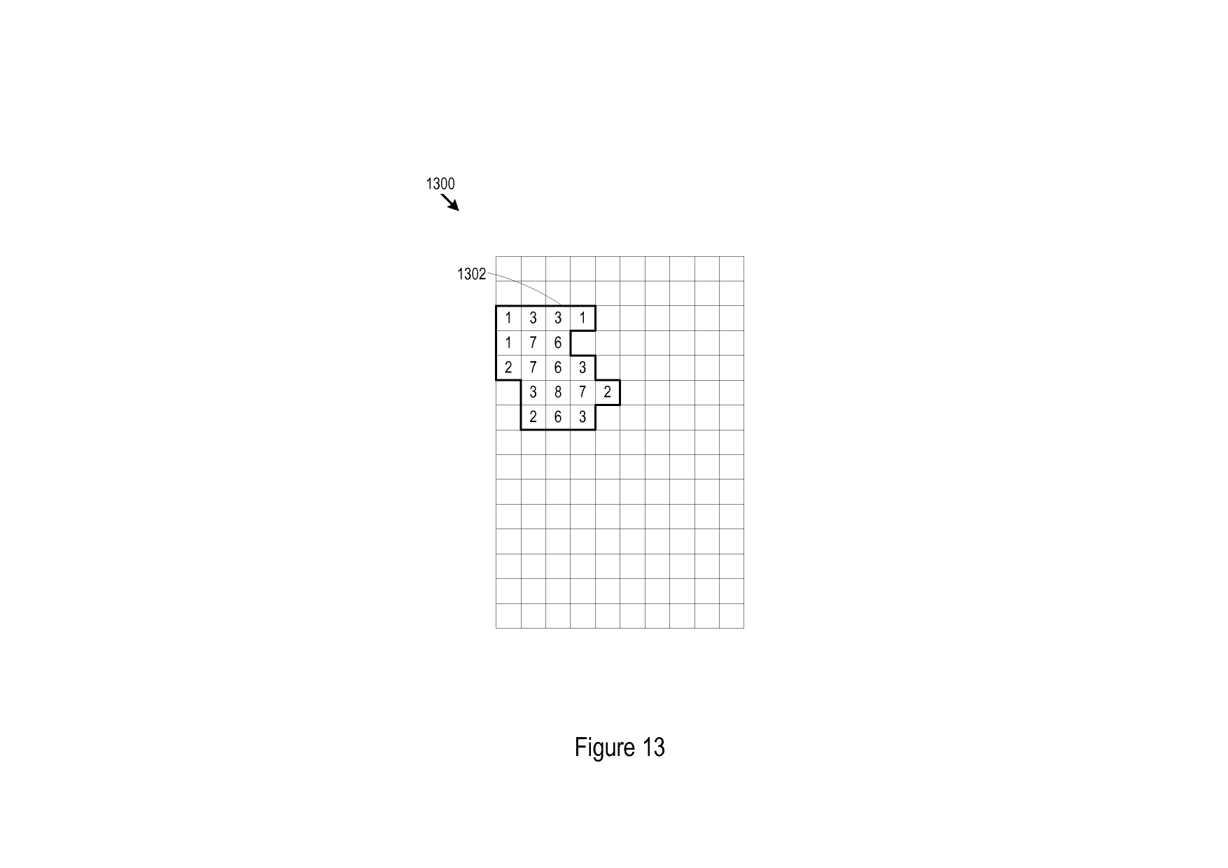

In some implementations, the system may perform its analysis not on raw capacitance values, but on delta capacitance: the difference between capacitance when the touchscreen is not touched, and the current reading. The current reading (the raw capacitance) decreases in the presence of a touch. Each area where the circuitry 104 detects interaction with the touch panel 1212 may show a change in capacitance values in that area of the touch panel 1212, with respect to the untouched panel. Such areas of changed capacitance are referred to as “blobs” due to the generally, but not necessarily, irregular shape of the heat map of change in capacitance values across multiple pixels at or near where an interaction with a finger or stylus (as examples) is occurring. FIG. 13 shows an example of a frame 1300 read from the touch panel 1212 currently being interacted with. The reading of the frame 1300 reveals the blob 1302. The change in capacitance values of the pixels in the blob 1302 are noted in the frame 1300. The values are for illustration only and are not meant to be representative of actual measurements.

The OCL 1210 provides several advantages:

In mutual capacitive touch systems, a variety of “touching objects” (TOs) may interact with the touch panel 1212. These TOs may be a finger touching the surface of the touch panel 1212, a passive metal stylus, a palm resting on the panel, a finger hovering some distance away from the touch panel 1212, or some other conductive object. The OCL 1210 helps classify the different TOs, which facilitates the device responding differently to those different TOs.

Additionally, classification of a TO may depend on the classification of other nearby TOs. For instance, if a palm is resting on the panel, then there is the likelihood that nearby touches are (perhaps unintentional) knuckle touches rather than intentional finger touches. Hence, the OCL 1212 may consider, for the TO classification, the relationship of nearby touches to one another.

The device may request or require that the control circuitry 104 filter out unintentional touches from being reported to the host, or to any other processing logic that uses the touch information from the touch panel 1212. Accordingly, the OCL 1210 facilitates correct classification of the TOs, and also intelligent action based on the classification.

The OCL logic 1210 may employ the following processing techniques, implemented in hardware, software/firmware, or both:

Object classification based on features of touch signal: The OCL 1210 may analyze multiple features of the touch blob in the capacitance image heat map together to classify a touch (e.g., as a hover touch, stylus touch, or finger touch). In one implementation, the OCL 1210 analyzes peak and curvature at the peak, and may also determine lines to separate feature space into regions (e.g., polygons), where a region corresponds to a touch class. The OCL 1210 may also debounce the classification decision, and latch the decision to ensure a consistent result.

Large area (palm) identification and rejection: The OCL 1210 may examine features of the touch blob to determine if the touch is a single, large touch. The OCL 1210 may use the number of peaks, area, and average curvature at one or more of the peaks to categorize the touch. In some situations, large touches are relatively smooth compared to close touches. The OCL 1210 may track large touches and suppress them even if the characteristics of the large touch seem to change.

Knuckle identification and rejection: When the OCL 1210 identifies a large area, any touch that is near the large area may be considered suspect. For example, the touch near the large area could be the pinky knuckle of a hand resting on the panel and holding a stylus. The OCL 1210 may identify such “knuckle” touches, suppresses them, and track them (even it they move relative to the palm) to ensure that they are not later reported as separate interesting touches.

Grip suppression: When gripping a mobile device, fingers may overlap on touch panel. The OCL 1210 may define multiple (e.g., three) areas (e.g., concentric area) of the screen. The OCL 1210 may suppress touches beginning in outer region unless the touch moves into the innermost region, because touches beginning in the outer region may actually represent the grip of fingers (for example) on the device. The OCL 1210 may not, for example, suppress touches beginning in inner two regions.

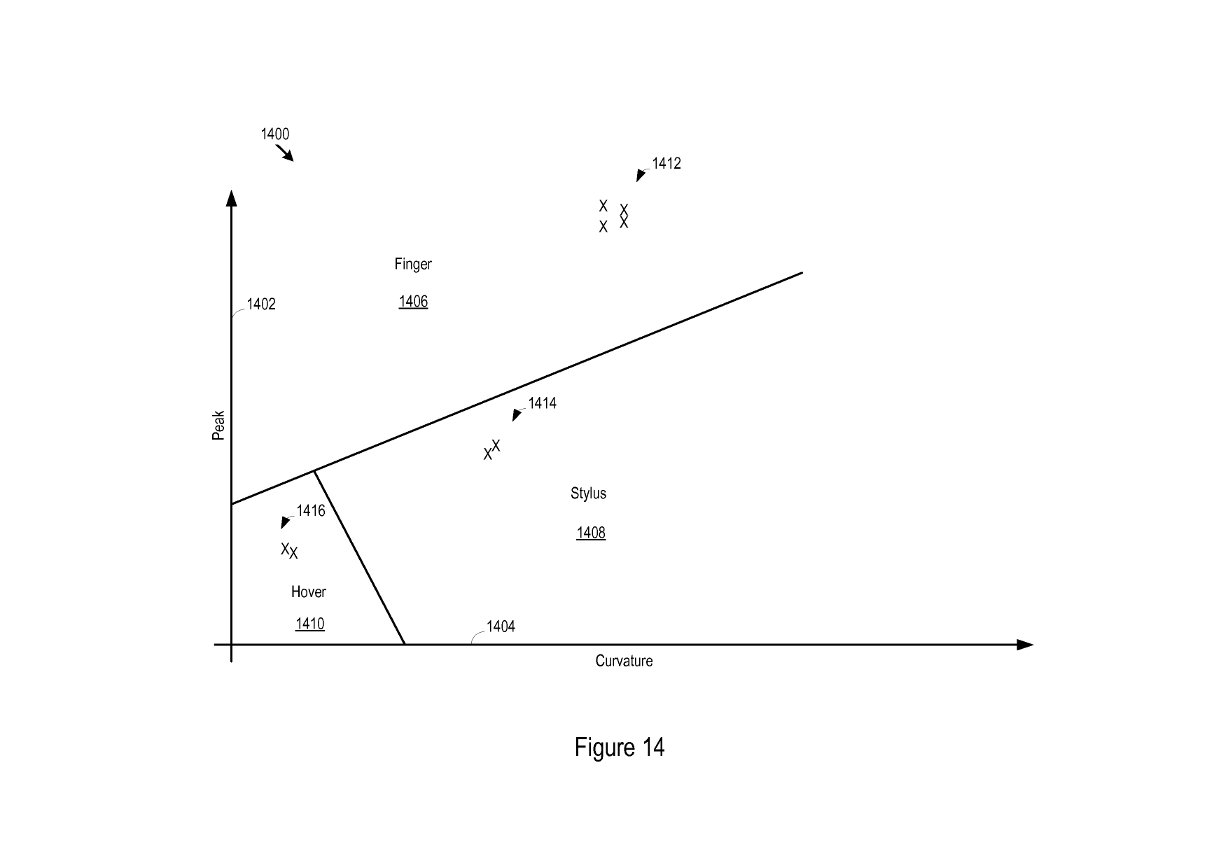

Regarding object classification, the OCL 1210 may define a space, e.g., by two axes, divide the space into regions, and then classify based on where measurements fall with respect to the regions. FIG. 14 shows an example of such a space 1400. The space 1400 is parameterized by the peak axis 1402 and the blob curvature axis 1404. The space 1400 is divided into three regions: the finger classification region 1406, the stylus classification region 1408, and the hover classification region 1410. In other implementations, the space 1400 may be divided into fewer, additional, or different regions using straight lines, curved lines, or any other shapes. Furthermore, additional, fewer, or different parameters (e.g., total change in capacitance in the blob) may be employed to partition the space. The partitioning of the space 1400 may be based on experimental measurements. Furthermore, a host may provide the OCL 1210 with parameters that define the space 1400 and the parameters may change dynamically during operation of the device, if desired. As one example, the host may provide the OCL 1210 with slope and intercept values, or other parameters, that divide the space 1400 into the regions shown in FIG. 14, or into any other set of regions. The parameters may reside in the OCL parameters 1219.

The peak axis 1402 may represent the largest capacitance measurement in the blob, an average of selected capacitance values in the blob, or some other function of a selected set of capacitance values of the blob. The curvature axis 1404 may represent the amount of curvature in the touch blob. The curvature measure may be a derivative measure to determine curvature. The amount of curvature may be the amount of curvature in a selected region of the blob. For example, the curvature may be measured as the average delta in value from the largest capacitance value to the values of its eight nearest neighbors, or other functions over a selected portion of the blob that reveals curvature. The curvature measure for any of the object classification techniques described above or below may be obtained in the same or different ways as just described.

Accordingly, when the OCL 1210 receives the measurements 1412, the OCL 1210 categorizes the touching object as a finger. When the OCL 1210 receives the measurements 1414, the OCL 1210 categorizes the touching object as a stylus. Similarly, when the OCL 1210 receives the measurements 1416, the OCL 1210 categorizes the touching object as a hover touch (e.g., as an object not directly touching the touch panel, but positioned above the touch panel and close enough to be influencing the capacitance measurements).

The OCL 1210 may use any number of measurements before making a classification and may debounce the decision. To debounce, the OCL 1210 may implement a categorization state machine. The state machine may start in the Uncategorized state, for example, and then make transitions based on the measurements to a different categorization state. If the measurements fall within a certain category, but less than a predefined amount of debounce time (or number of frame scans) has passed since the measurements started to fall within the category, then the OCL 1210 may wait to report the categorization (or report Unknown or Uncategorized) until the measurements have fallen within a certain category for more than the predetermined debounce time. Once the OCL 1210 makes a decision, the OCL 1210 may latch the decision for that blob, and keep the same classification as long as the blob is on the touch panel. Alternatively, the OCL 1210 may allow the category to change, for example, after a predetermined period of time has passed, or based on the new apparent category for the touch object (as examples: a finger may change to a hover, but not to a stylus).

Regarding palm rejection, the OCL 1210 may analyze a blob in the following manner: find the peaks (e.g., capacitance values above a particular threshold value), compute the curvature at each peak, and average the curvatures. The OCL 1210 may use the capacitance values obtained from the touch panel 1212 without, or with, interpolation. Thus, for example, when the touch panel 1212 is an array of 30 rows by 40 columns, the OCL 1210 may analyze capacitance values at the pixels of the 30×40 grid, or may interpolate to obtain additional inter-grid values.

The average of the curvatures provides a curvature measure of how bumpy or smooth the blob is. Other measures may also be used, such as the distance between peaks, the narrowness of the peaks, height of the peaks, depth of the valleys, distance between valleys, or the area of the blob. The OCL 1210 may determine that, as examples, if a blob exceeds a predetermined number of peaks, has more than a preconfigured number of sharp valleys, or exceeds a predetermined threshold for the curvature measure, that the blob actually represents multiple smaller touch objects interacting with the touch panel 1212. Otherwise, the OCL 1210 may determine that the blob represents one large touch object, such as a palm, cheek, elbow, or other large touch object.

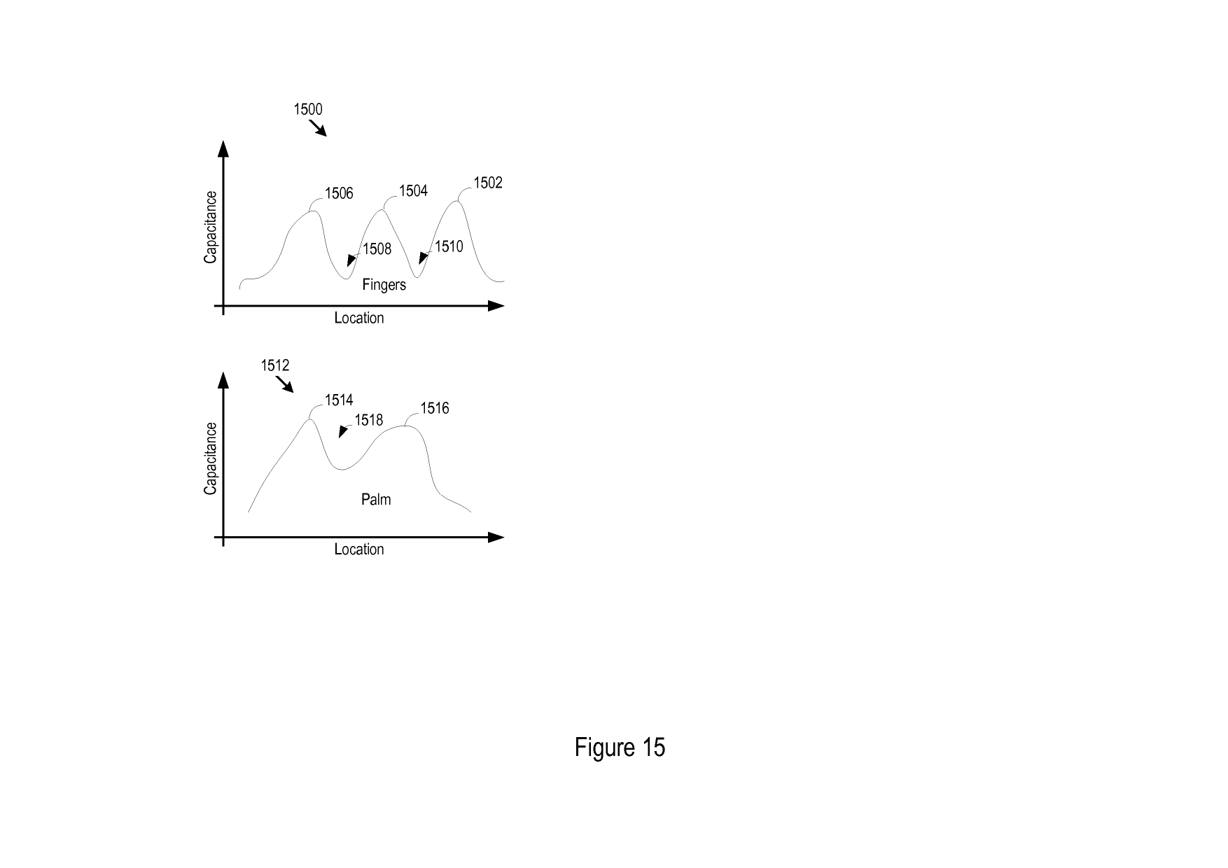

FIG. 15 shows two dimensional examples of a blob 1500 that has a high curvature measure. The high curvature measure results from three fingers on the touch panel 1212 at the same time creating multiple strong, narrowly separated peaks 1502, 1504, 1506 and valleys 1508, 1510. FIG. 15 also shows a two dimensional example of a blob 1512 that has a lower curvature measure. The lower curvature measure results from a large object, such as a palm with two peaks 1514 and 1516 and a shallow central valley 1518.

In some implementations, the OCL 1210 may detect large blobs with a single peak that exceeds a predetermined height threshold (e.g., for the peak) and/or area threshold. Such blobs may be rejected, or not reported to the host. For example, such a blob may represent the large area of a thumb pressing down on the touch panel 1212. In other words, the blob may be too big to be a finger, and the OCL 1210 may be configured to reject non-finger touches, or not report the non-finger touches to the host.

With regard to knuckle identification, the OCL 1210 may recognize that with palm (or large object) touch, there may be ancillary touches nearby. For example, the side of the palm may rest on the touch screen 1212 along with the knuckle of the pinky (possible separated by a gap). The ancillary touches (e.g., the pinky knuckle) may look separate, but their presence with the large object characterizes them as part of the large object interaction with the touch panel 1212. Accordingly, the OCL 1210 may determine that when a large object exists, then any additional objects within a predetermined distance threshold (of the large object centroid, or from the peak value, or other point of the large object blob) in the heat map may be associated with the large object, and consequently reject or not report those additional objects. The OCL 1210 may track the additional objects, and if the additional object moves away from the large object blob, then the OCL 1210 may determine that the additional object will be reported as a separate touch interaction.

The OCL 1210 may also debounce the knuckle determination as well as the large object determination. This prevents rapid fluctuations between reporting the additional objects and not reporting the additional objects (or palm). For the palm detection, the debouncing may prevent the categorization as a large object from changing regardless of how small the blob becomes until the blob effectively disappears from the touch panel 1212 altogether. Other implementations of debouncing are possible as well, such as keeping the blob categorized as a large object unless the blob falls under a specific threshold and not recategorizing as a large object until the blob becomes blob passes a second larger threshold in size.

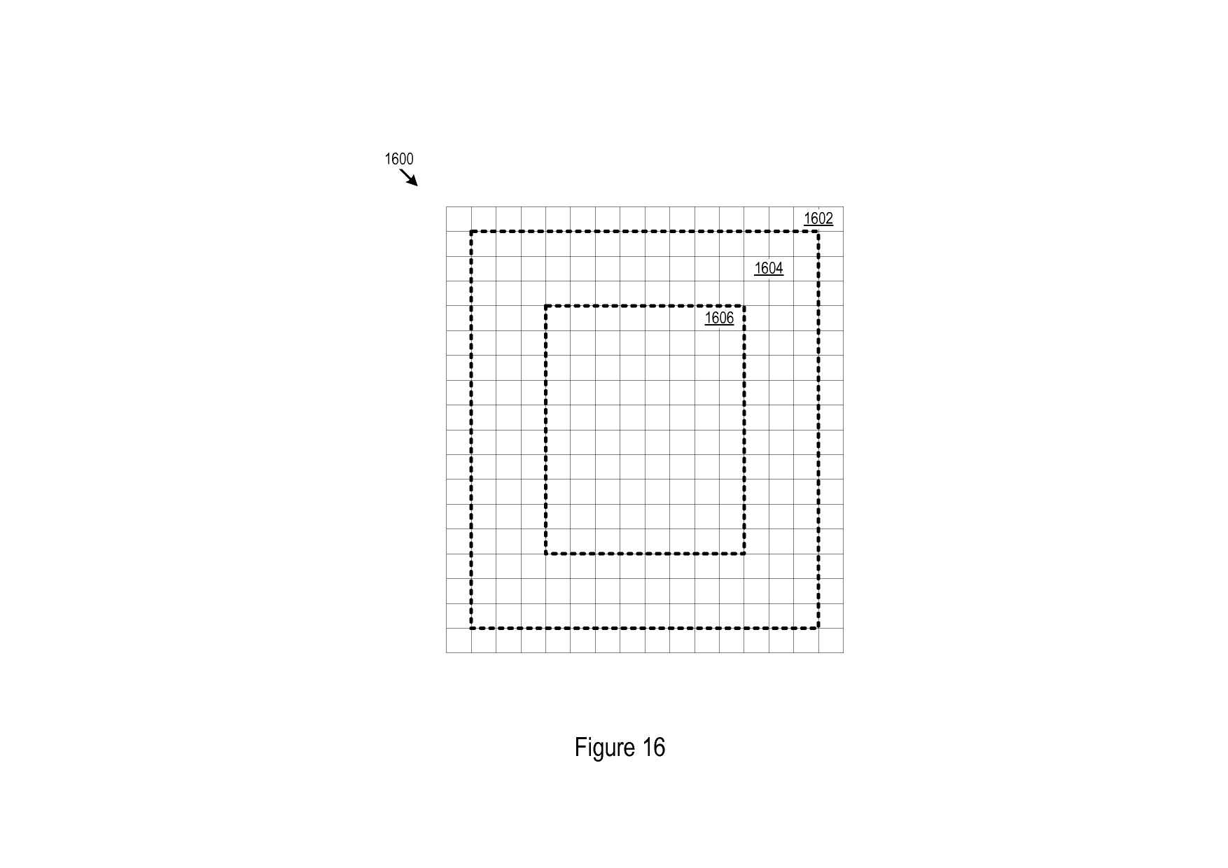

With regard to grip suppression, in some cases fingers may wrap around the device and touch the touch panel 1212 along the edges. FIG. 16 shows a touch panel which the OCL 1210 has divided into regions (three regions) in this example: the outer region 1602, the middle region 1604, and the center region 1606. The number, size, shape and position of the regions may be set as OCL parameters 1219.

The OCL 1210 detect touches that start in the outer region 1602 (which is preferably small). If the touch starts there, then the OCL 1210 may reject or not report that touch to the host (under the assumption that the touch results from a grip on the edge of the device). If the touch starts in the center region 1606, the OCL may report that touch to the host. Furthermore, the OCL may track the touch position, and regardless of where the touch goes (even into the outer region 1602), may report the touch to the host. If a touch starts in the middle region 1604, the OCL 1210 may consider the touch as a valid touch as report the touch to the host. Furthermore, the OCL 1210 may track the touch and continue to report the touch regardless of where the touch goes. In some implementations, the OCL 1210 determines that a touch that starts in the outer region 1602 and moves into the middle region 1604 still remains a grip touch (as is therefore not reported to the host). However, if the touch moves all the way into the center region 1606, then the OCL 1210 may report the touch to the host (and not consider the touch a grip touch going forward).

As examples of the region sizes, the outer region 1602 may be a fraction (e.g., one tenth to one fifth) of a row and a column of the grid, for example 0.5 mm to 1 mm in width. The middle region 1604 may be an additional 1 mm to 2 mm in from the outer region 1602. The center region 1606 may be the remainder of the touch panel 1212. However, these sizes may vary widely depending on the implementation, and may be stored as OCL parameters 1219 and set ahead of time, or changed dynamically by the host.

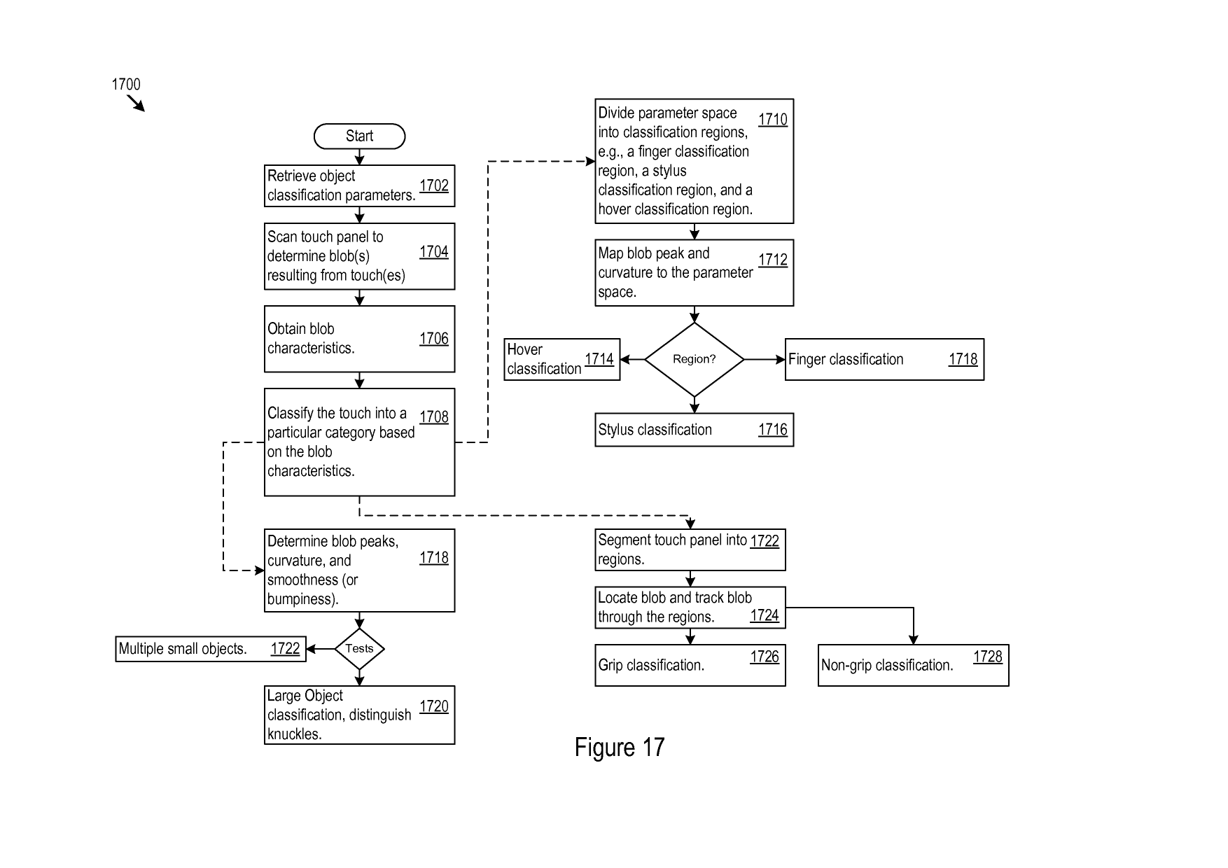

FIG. 17 shows logic that the OCL 1210 may implement. The OCL 1210 may retrieve the OCL parameters 1219 (1702). The control logic 104 scans the touch panel 1212 to determine blobs resulting from touches (1704). The OCL 1210 determines blob characteristics such as peak capacitance, curvature, area, number of peaks, location of blob, and other characteristics noted above (1706). The OCL 1210 then classifies the touch into a particular category based on the blob characteristics (1708). As examples, the categories may include a hover category, finger category, stylus category, grip category, knuckle category and/or a large object category.

As one particular example, the OCL 1210 may divide a parameter space into classification regions (1710). The OCL 1210 may then map blob peak, curvature, and/or other parameters to the parameter space (1712). Based on the region in which the blob is within the parameter space, the OCL 1210 determines, as examples, a hover classification (1714), a finger classification 1718, or a stylus classification 1716.

The OCL 1210 may also determine blob peaks, curvature, and smoothness or bumpiness (1718). These parameters may determine, as explained above, whether the blob represents a large object (and whether nearby touches are knuckles) (1720), or whether the blob represents multiple small objects (1722).

The OCL 1210 may also segment the touch panel into regions (1722), such as the outer region 1602, the middle region 1604, and the center region 1606. The OCL 1210 locates the blob with respect to the regions and tracks the blob through the regions (1724). The resulting classification may be, as examples, a grip classification (1726) or a non-grip classification (1728). Between scans of the touch panel 1212, the OCL logic 1210 may recognize the blob using a shape recognition algorithm, or by closeness to the last blob position (because blobs do not tend to move quickly in comparison to the scan frame rate), or in other manners.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1-20. (canceled)

21. A method for object classification, the method comprising:
obtaining a blob characteristic of a touch panel blob associated with a touch on a touch panel; and
determining a touch category for the touch using the blob characteristic.

22. The method of claim 21, where determining comprises:
segmenting a parameter space into subspaces corresponding to different categories of touches which include the touch category.

23. The method of claim 22, where segmenting comprises:
segmenting the parameter space into:
a finger subspace corresponding to a first category of touch;
a hover subspace corresponding to a second category of touch;
a stylus subspace corresponding to a third category of touch, or any combination thereof.

24. The method of claim 21, where determining comprises:
segmenting a parameter space comprising a peak axis and a curvature axis into subspaces.

25. The method of claim 21, where obtaining a blob characteristic comprises:
obtaining a blob curvature of the touch panel blob as the blob characteristic; and
where determining further comprises:
segmenting a parameter space into subspaces corresponding to different categories of touches which include the touch category; and
locating the blob curvature in the parameter space.

26. The method of claim 21, where obtaining a blob characteristic comprises:
obtaining a blob peak of the touch panel blob as the blob characteristic; and
where determining further comprises:
segmenting a parameter space into subspaces corresponding to different categories of touches which include the touch category; and
locating the blob peak in the parameter space.

27. The method of claim 21, where determining comprises:
defining grip regions with respect to the touch panel; and
determining position over time of the touch panel blob with respect to the grip regions; and
determining the touch category to be a grip category in response to the position over time.

28. A system comprising:
a touch panel interface; and
logic in communication with the touch panel interface that is configured to:
communicate with the touch panel interface to obtain a blob characteristic of a touch panel blob;
perform an analysis on the blob characteristic; and
assign a touch category to the touch panel blob based on the analysis.

29. The system of claim 28, where the analysis comprises:
locating the blob characteristic in a subspace of a parameter space.

30. The system of claim 29, where the subspace comprises:
a finger subspace representing a touch by a finger;
a hover subspace representing a hovering finger;
a stylus subspace representing a stylus touch, or any combination thereof.

31. The system of claim 28, where the blob characteristic comprises:
a peak measurement, a curvature measurement, or both.

32. The system of claim 28, where:
the blob characteristic comprises a blob curvature; and
the analysis comprises locating the blob curvature among multiple subspaces of a parameter space.

33. The system of claim 28, where:
the blob characteristic comprises a blob peak; and
the analysis comprises locating the blob peak among multiple subspaces of a parameter space.

34. The system of claim 28, where:
the blob characteristic comprises position over time; and
the analysis comprises determining the position over time with respect to grip regions.

35. A device comprising:
a touch panel;
a touch panel interface in communication with the touch panel;
a memory; and
a processor in communication with the touch panel interface and the memory, the memory comprising:
object classification parameters; and
object classification logic operable to, when executed by the processor:
read the object classification parameters;
scan the touch panel to obtain a touch characteristic of a touch on the touch panel;
analyze the touch characteristic with respect to the object classification parameters to determine a touch category for the touch.

36. The device of claim 35, where the object classification parameters comprise subspaces defined in a parameter space, each subspace representing different category of touch.

37. The device of claim 36, where the subspaces comprise a finger subspace, a hover subspace, a stylus subspace, or any combination thereof.

38. The device of claim 35, where the object classification parameters comprise a grip region with respect to the touch panel.

39. The device of claim 38, where the touch characteristic comprises a position over time of the touch with respect to the grip region.

40. The device of claim 35, where the object classification parameters comprise a peak parameter, a curvature parameter, or both, adapted to distinguish the touch between a large object and multiple small objects.
